(19) United States
(12) Patent Application Publication
(10) Pub. No.: US 2025/0280441 A1
(43) Pub. Date: Sep. 4, 2025

(54) IMPROVED r-TWT-BASED COMMUNICATION METHODS FOR P2P STREAM

(71) Applicant: CANON KABUSHIKI KAISHA, Tokyo (JP)

(72) Inventors: Romain GUIGNARD, RENNES (FR); Pascal VIGER, JANZE (FR)

(21) Appl. No.: 18/858,492

(22) PCT Filed: Apr. 19, 2023
(86) PCT No.: PCT/EP2023/060107

§ 371 Date: Oct. 21, 2024

(30) Foreign Application Priority Data
Apr. 22, 2022 (GB) 2205902.6
Mar. 10, 2023 (GB) 2303581.9

(51) Int. Cl. H04W 74/0816; H04W 74/04; H04W 76/14

(52) U.S. Cl. CPC H04W 74/0816; H04W 74/04; H04W 76/14

(57) ABSTRACT

To facilitate P2P transmissions within a restricted Target Wake Time, rTWT, schedule, an AP of a BSS that has established membership of a peer station in the rTWT schedule and that detects P2P traffic between the peer station and a partner peer station of the BSS, may notify the partner peer station about the existing rTWT schedule. The AP may further invite the peer stations to establish a Direct Link communication session. The notification may be included in said invitation or be carried through an unsolicited TWT frame enrolling the partner peer station in the rTWT schedule. It turns out that the partner peer station now wakes up for the service periods of the rTWT schedule, hence facilitating the direct or relayed transmission of P2P data within one and the same service period.

### FIELD OF THE INVENTION

The present invention generally relates to wireless communications and more specifically to Peer-to-Peer (P2P) communication.

### BACKGROUND OF INVENTION

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

Low latency reliable services, LLRS, have been defined as targets of such main objective. LLRSs are services provided to a higher layer traffic stream that prioritize and deliver MSDUs (data units) within a worst-case latency budget with a given reliability/packet delivery ratio (PDR) and low jitter.

The IEEE P802.11be/D1.5 version (March 2022, below the “D1.5 standard”) introduces the Multi-link (ML) operation (MLO). MLO improves data throughput by allowing communications between stations over multiple concurrent and non-contiguous communication links.

Multi-Link Operation enables a non-AP (access point) MLD (ML device) to register with an AP MLD, i.e. to discover, authenticate, associate and set up multiple links with the AP MLD. Each link enables channel access and frame exchanges between the non-AP MLD and the AP MLD based on supported capabilities exchanged during association.

A MLD is a logical entity that has more than one affiliated station (AP or non-AP) and has a single medium access control (MAC) service access point (SAP) to logical link control (LLC), which includes one MAC data service. An AP MLD is thus made of multiple affiliated APs whereas a non-AP MLD is made of multiple affiliated non-AP stations. The affiliated stations in both AP MLD and non-AP-MLD can use 802.11 mechanisms to communicate with affiliated stations of another MLD over each of the multiple communication links that are set up.

To meet low latency requirements in EHT as well as to increase efficiency of the UL MU operation, existing mechanisms have been reused within the D1.5 standard and improved, while other new mechanisms have been added.

The Stream Classification Service (SCS) mechanism, originally defined in the IEEE 802.11aa standard, has been adapted to be included in the D1.5 standard. The SCS mechanism for multi-link now allows a non-AP MLD to define and advertise the AP MLD of a (latency sensitive) traffic stream identified with an SCS identifier, SCSID. An adaptation of the SCS mechanism allows QoS requirements to be defined for the SCS stream through so-called QoS Characteristics element, in particular to classify the SCS stream as belonging to a TID class for a corresponding uplink (UL) or downlink (DL) direction.

The Target Wake Time (TWT) mechanism, originally defined in the IEEE 802.11ah and 802.11ax standards, has been adapted to be included in the D1.5 standard. An adaptation is known as the Restricted Target Wake Time (rTWT) which schedules dedicated (and protected) service periods (SPs) for stations to convey their latency sensitive traffic(s), e.g. SCS streams, over the BSS. An rTWT agreement is nothing more than a Broadcast TWT agreement negotiated between an AP and an associated non-AP station of the BSS. The non-AP station establishes with the AP membership in a Broadcast TWT (or rTWT) schedule. The schedule may be defined for some TIDs (i.e. QoS characteristics) as specified through the SCS mechanism. The rTWT Service Periods SPs of the rTWT schedule, in which the protected exchanges of SCS traffic streams may take place, are advertised in broadcast management frames (e.g. beacons), using an rTWT information about the negotiated rTWT SPs, typically a Broadcast TWT ID (bTWT ID).

The new Triggered TXOP Sharing (TXS) mechanism allows an AP to allocate a portion of the time within an obtained TXOP to only one associated non-AP 802.11be station for the latter to transmit one or more non-TB PPDUs. This looks like single-user (SU) triggering. A specific trigger frame is used to that end which is called MU-RTS TXS and specifies the time duration allocated to the non-AP station within the TXOP obtained by the AP. The TXS mechanism facilitates P2P (peer-to-peer or Direct Link-DiL) communications within a TXOP obtained by the AP.

These various mechanisms operate together with difficulties, in particular with respect to latency sensitive P2P traffics.

On one hand, the AP-centric aspect of the 802.11 MU transmission scheme involved in the SCS and rTWT mechanisms is not adapted to bandwidth-demanding communication services (e.g. video-based services such as gaming, virtual reality, streaming applications) because all the communications go through the AP, thereby doubling the air time for transmission but also the number of medium accesses (and thus of medium access time).

On the other hand, as the SCS and rTWT mechanisms are negotiated between an initiator non-AP station and the AP, hence excluding the other peer non-AP station partner to the P2P (or DiL) communication with the initiator peer non-AP station, there are few chances that the partner peer non-AP station be awake and therefore available for TXS-based P2P communication within an rTWT SP of the negotiated rTWT schedule.

In other words, the D1.5 standard is for the moment not satisfactory with respect to P2P or DiL transmissions. Transmissions as conventionally specified through rTWT can be improved.

### SUMMARY OF THE INVENTION

It is a broad objective of the present invention to overcome some of the foregoing concerns.

The inventors have sought to improve this situation by taking benefit of the promising rTWT mechanism to facilitate the P2P communications. In this context, they have searched for mechanisms to correctly (given the standardized mechanisms) involve the partner peer non-AP station in the rTWT schedule, in order for the partner peer to be awake for the rTWT SPs of the schedule, hence to be available for P2P communication within that rTWT SPs.

In this context, there is provided a peer-to-peer, P2P, communication method in a wireless network, comprising at an access point, AP, of a BSS:
establishing membership of a first peer non-AP station of the BSS in a restricted Target Wake Time, rTWT, schedule,
determining P2P data traffic between the first peer non-AP station and a second (the partner one) peer non-AP station of the BSS, and
responsive to the determining, notifying the second peer non-AP station about the rTWT schedule.

From the peer perspective, there is provided a peer-to-peer, P2P, communication method in a wireless network, comprising at a second peer non-access point, AP, station of a BSS:
receiving, from an AP of the BSS, a notification about a restricted Target Wake Time, rTWT, schedule in which a first peer non-AP station of the BSS has established membership, and
exchanging, during one or more rTWT service periods of the rTWT schedule, P2P data with the first peer non-AP station.

On AP's initiative, the second peer non-AP station (the partner one) is now made aware of the rTWT schedule, and can awake at the time of an rTWT SP of the rTWT schedule adhered by the partner peer. P2P data can therefore be exchanged between the two peer non-AP stations within one and the same rTWT SP.

Optional features of the invention are defined below with reference to a method, while they can be transposed into device features.

In some embodiments, the determining includes relaying P2P data exchanged between the two peer non-AP stations. For instance, the AP may receive P2P data from the first peer non-AP station, to be relayed to the second peer non-AP station.

In other embodiments, the determining includes receiving P2P session setup frames exchanged between the two peer non-AP stations, to be relayed to the second peer non-AP station.

In yet other embodiments, the determining includes receiving an indication of P2P data traffic within a frame to establish the membership in the rTWT schedule or a frame to setup a Stream Classification Service, SCS, P2P traffic stream.

In some embodiments, the method at the AP further comprises obtaining an identifier (AID or MAC address) of the second peer non-AP station to address the notification, wherein obtaining the identifier includes one of the following:
retrieving a transmitter or destination MAC address of a MAC frame of P2P-related frame exchanged between the two peer non-AP stations, (e.g. P2P data or P2P session setup frames relayed by the AP)
retrieving a MAC address or an Association Identifier, AID, of the second peer non-AP station from a STA Information Announcement frame sent by the first peer non-AP station to announce a partner peer non-AP station,
retrieving an AID of the second peer non-AP station from an rTWT Setup frame sent by the first peer non-AP station to establish its membership in the rTWT schedule, and
retrieving an AID of the second peer non-AP station from a Stream Classification Service, SCS, Request frame sent by the first peer non-AP station to categorize a P2P traffic stream to be addressed to the second peer non-AP station.

In particular embodiments, the AID of the second peer non-AP station is carried in an additional subfield to the QoS Characteristics element as defined in IEEE 802.11be/D1.5 of March 2022 or as defined in contribution IEEE 802.11-22/0200r0 of January 2022. Such element may be provided in the rTWT Setup frame or the SCS Request frame.

In alternative embodiments, the AID of the second peer non-AP station is carried in an additional subfield to the Restricted TWT Traffic Info field as defined in IEEE 802.11be/D1.5 of March 2022. Such element is usually provided in the rTWT Setup frame.

In some embodiments, notifying the second peer non-AP station about the rTWT schedule includes establishing membership of the second peer non-AP station in the rTWT schedule. In that case, the AP not only informs the second peer of the rTWT schedule but also enrolls it in said rTWT schedule so that the AP can offer it resources during service periods of said schedule. From peer perspective, it means the notification about the rTWT schedule includes establishing membership of the second peer non-AP station in the rTWT schedule.

In particular embodiments, establishing membership of the second peer non-AP station includes sending, to the second peer non-AP station, an unsolicited TWT Setup frame signaling the rTWT schedule. From peer perspective, it means establishing membership of the second peer non-AP station includes receiving, from the AP, an unsolicited TWT Setup frame signaling the rTWT schedule.

In some embodiments, the notification further signals an identifier of the first peer non-AP station. This is to allow the second peer to have all knowledge to take an appropriate decision.

In some embodiments, the method at the AP further comprises, responsive to the determining, sending, to one of the peer non-AP stations, an invitation to establish a Direct Link communication session with the other peer non-AP station. This advantageously minimizes the two hops P2P communication latency in the BSS. From peer perspective, the method further comprises receiving, from the AP, an invitation to establish Direct Link communication session with the first peer non-AP station.

It is to be noted that the invitation may include the notification about the rTWT schedule. In that case the invitation is sent to the second peer station to inform it about the existence of the rTWT schedule.

In particular embodiments, sending the invitation includes sending an unsolicited TDLS Discovery frame on behalf of the other peer non-AP station, wherein the TDLS Discovery frame identifies the other peer non-AP station. This usually triggers, here on AP's initiative, the setup of a TDLS session between the two peer stations. From peer perspective, receiving the invitation includes receiving an unsolicited TDLS Discovery frame on behalf of the first peer non-AP station, wherein the TDLS Discovery frame identifies the first peer non-AP station.

According to some features, the method at the AP further comprises receiving, from the one of the peer non-AP stations, a response to the invitation confirming the establishment of the Direct Link communication session between the two peer non-AP stations. From peer perspective, the method further comprises, responsive to the invitation, establishing a P2P session with the first peer non-AP station and sending, to the AP, a response to the invitation confirming the establishment of the Direct Link communication session.

In some embodiments, the method at the AP further comprises, prior to the determining, establishing membership of the second peer non-AP station in a separate rTWT schedule, wherein the notifying includes requesting the second peer non-AP station to switch its membership from the separate rTWT schedule to the rTWT schedule of the first peer non-AP station. From peer perspective, the method further comprises, prior to receiving the notification, 20 establishing, with the AP, membership in a separate rTWT schedule, wherein the notification includes a request to switch its membership from the separate rTWT schedule to the rTWT schedule in which the first peer non-AP station has established membership.

In some embodiments, the method at the AP further comprises, after the notification, receiving P2P data from one of the peer non-AP stations and relaying them to the other peer non-AP station within the same rTWT Service Period of the rTWT schedule.

The P2P data may be received in HE Trigger-Based PPDUs and be relayed using HE MU PPDUs.

From peer perspective, the method further comprises, after receiving the notification, receiving, from the AP and within an rTWT Service Period of the rTWT schedule, P2P data emitted by the first peer non-AP station.

In some embodiments, the method at the AP further comprises, after the notification, allocating, using the Triggered TXOP Sharing, TXS, mechanism, one of the peer non-AP stations with a portion of time within an rTWT Service Period of the rTWT schedule. From peer perspective, the method further comprises, after receiving the notification, being allocated, based on the Triggered TXOP Sharing, TXS, mechanism, a portion of time within an rTWT Service Period of the rTWT schedule and directly exchanging P2P data with the first peer non-AP station within the allocated time portion.

In some embodiments, the two peer non-AP stations have established a P2P session prior to the notification.

In some embodiments, the notification about the rTWT schedule includes information about a Broadcast TWT identifier, bTWT ID, identifying the rTWT schedule.

For example, the notification about the rTWT schedule provides only the bTWT ID as TWT information. This approach reduces overhead while providing simplicity to signal the rTWT SPs.

In another example, notifying about the rTWT schedule provides a Broadcast TWT Info subfield including the bTWT ID. This approach advantageously signals the second peer about the time window (lifetime) within which the rTWT SPs are provided. Indeed, the D1.5 standard provides that the Broadcast TWT Info subfield includes the Broadcast TWT Persistence indication to that end.

In yet another example, notifying about the rTWT schedule provides a Restricted TWT Parameter Set subfield including the bTWT ID. The second peer is then provided with complete information about the rTWT SPs.

In some embodiments, the peer non-AP stations are affiliated to respective non-AP multi-link devices, MLDs. The above management of P2P communications can therefore be implemented at each or multiple links of the non-AP MLDs.

Correlatively, the invention also provides a wireless communication device comprising at least one microprocessor configured for carrying out the steps of any of the above methods. The wireless communication device may be either of a non-AP MLD and an AP MLD.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical wireless communication system in which embodiments of the invention may be implemented;

FIG. 2 illustrates, using frame exchanges in a timeline, a possible scenario for an initiator peer non-AP STA to handle P2P traffic;

FIG. 3 illustrates the data payload, in the format of a Tunneled Direct Link Setup, TDLS, Action frame, of a Data frame;

FIG. 4 illustrates a Stream Classification Service, SCS, descriptor included in SCS frames;

FIG. 5 illustrates a format of a Target Wake Time, TWT, element adapted to be used for r-TWT according to the D1.5 standard.

FIG. 6 illustrates, using flowcharts, exemplary steps at the AP MLD (or AP) and one of the peer MLDs (stations) according to some embodiments of the invention.

FIG. 7 illustrates, using a flowchart, exemplary steps at the AP according to first embodiments of the invention, where two peer stations have established a DiL communication session prior to the AP notifying partner peer of the rTWT schedule adhered by the other peer.

FIG. 8 illustrates, using frame exchanges in a timeline, a scenario corresponding to FIG. 7.

FIG. 9a illustrates a modified QoS Characteristics element according to some embodiments, to include a Peer STA ID subfield to signal the notified partner peer with an identifier of the other peer.

FIG. 9b illustrates another modified QoS Characteristics element according to other embodiments, to include a Peer STA ID subfield to signal the notified partner peer with an identifier of the other peer.

FIG. 10 illustrates a modified TWT element according to some embodiments, to include a Peer STA ID subfield to signal the notified partner peer with an identifier of the other peer.

FIG. 11 illustrates, using a flowchart, exemplary steps at the AP according to second embodiments of the invention, where two peer stations do not establish a Direct Link communication session.

FIG. 12 illustrates, using frame exchanges in a timeline, a scenario corresponding to FIG. 11.

FIG. 13 illustrates, using a flowchart, exemplary steps at the AP according to third embodiments of the invention, where TWT scheduling AP invites the partner peer station to establish a Direct Link communication session with the peer station.

FIG. 14 illustrates, using frame exchanges in a timeline, a scenario corresponding to FIG. 13.

FIG. 15 illustrates, using frame exchanges in a timeline, another scenario corresponding to FIG. 13.

FIG. 16 illustrates, using a flowchart, exemplary steps at the AP according to third embodiments of the invention, where two peer stations have previously established respective membership in separate rTWT schedules managed by the AP.

FIG. 17 illustrates, using frame exchanges in a timeline, a scenario corresponding to FIG. 16.

FIG. 18a shows a schematic representation a communication device according to at least one embodiment of the present invention; and

FIG. 18b illustrates schematically the architecture of the communication device of FIG. 18a.

### DETAILED DESCRIPTION OF THE INVENTION

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to transmit simultaneously data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

While the examples are described in the context of WiFi (RTM) networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base STA (gNB), Base STA Controller (“BSC”), Base Transceiver STA (“BTS”), Base STA (“BS”), Transceiver Function (“TF”), Radio Router, Radio Transceiver, Basic Service Set (“BSS”), Extended Service Set (“ESS”), Radio Base STA (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

The 802.11 family of standards define various media access control (MAC) mechanisms to drive access to the wireless medium.

The current discussions in the task group 802.11be, as illustrated by draft IEEE P802.11be/D1.5 of March 2022, introduce the Multi-Link Operation (MLO) when it comes to MAC layer operation. The MLO allows multi-link devices to establish or setup multiple links and operate them simultaneously.

A multi-link device (MLD) is a logical entity and has more than one affiliated (AP or non-AP) station (STA) and has a single medium access control (MAC) service access point (SAP) to logical link control (LLC), which includes one MAC data service. Besides, the MLD also comprises a single address associated with the interface, which can be used to communicate on the distribution system medium (DSM).

The stations forming the same MLD may be partly or all collocated within the same device or geographically dispersed.

An access point multi-link device (AP MLD) corresponds to a MLD where each station (STA) affiliated with the MLD is an AP, referred to as “affiliated AP” hereinafter.

A non-access point multi-link device (non-AP MLD) corresponds to a MLD where each station (STA) affiliated with the MLD is a non-AP station, referred to as “affiliated non-AP station”.

When referring hereinafter to either an AP MLD or a non-AP MLD, the general term “station MLD” may be used.

Depending on the literature, “multilink device”, “ML device” (MLD), “multilink logical entity”, “ML logical entity” (MLE), “multilink set” and “ML set” are synonyms to designate the same type of ML device.

Multiple affiliated non-AP STAs of a non-AP MLD can then setup communication links with multiple affiliated APs of an AP MLD, hence forming a multi-link channel. This is for instance done through the conventional association procedure: ML Discovery including passive scanning (ML beacons) or active scanning (ML Probe Request and corresponding Response), following by ML Authentication and finally by ML Setup where the non-AP MLD associates with the AP MLD (hence obtained an Association IDentifier, AID) and sets up the ML links for its affiliated non-AP STAs with the APs affiliated with the AP MLD.

The links established (or “enabled links”) for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHz, 40 MHz, and so on) in a given frequency band (e.g. 2.4 GHz, 5 GHz, 6 GHz) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

The terms “traffic” and/or “traffic stream(s)” as used herein, are defined as a data flow and/or stream between wireless devices.

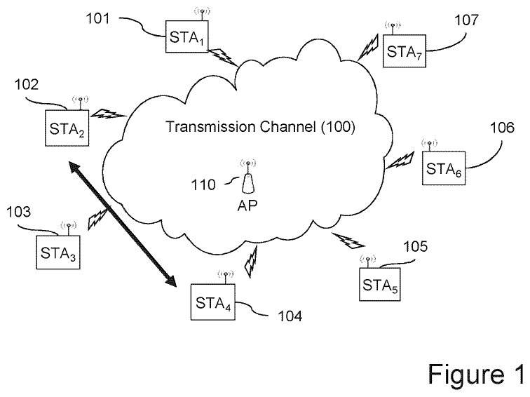

FIG. 1 illustrates a wireless communication system in which several communication station devices 101-107, 110 exchange data frames over a radio transmission channel 100 of a wireless local area network (WLAN), under the management of a central station, namely access point device (AP) 110. Direct communications between STAs can also be implemented without the use of an access point (known as an Ad-hoc mode). The radio transmission channel 100 is defined by an operating frequency band constituted by a single channel, a plurality of channels forming a composite channel, or a plurality of distinct channels (links) forming a multi-link operation.

In the following description, the term “station” or “STA” may be used to describe a non-AP station operating on a given link of 100, which may be a standalone non-AP station or an affiliated non-AP station entity of a non-AP MLD device. Similarly, the term “AP” describes an AP station operating on a given link, which may be a standalone AP station or an affiliated AP station entity of an AP MLD device.

Exemplary situations of direct communications, corresponding to an increasing trend nowadays, include the presence of peer-to-peer (P2P, also known as Direct Link or “DiL”) transmissions in between non-AP stations, e.g. STA 102 and STA 104 as illustrated in the Figure. Technologies that support P2P transmissions are for example WiFi-Miracast (RTM) or Wireless Display scenario, or Tunneled Direct Link Setup (TDLS). Note that even if P2P flows are usually not numerous, the amount of data per flow may be huge (typically low-compressed video, from 1080p60 up to 8K UHD resolutions).

Each STA 101-107 registers to the AP 110 during an association procedure. During the association procedure, the AP 110 assigns a specific Association IDentifier (AID) to the requesting STA. For example, the AID is a 16-bit value uniquely identifying the STA. When the AP and non-AP STA are respectively an affiliated AP of an ML AP device and an affiliated non-AP of a ML non-AP device, they establishing a ML association wherein an unique AID is assigned to the entire non-AP MLD: all affiliated non-AP STAs are identified by same AID value on their respective operation link.

The stations 101-107, 110 may compete on a given link one against the other using EDCA (Enhanced Distributed Channel Access) contention, to access the wireless medium in order to be granted a transmission opportunity (TXOP) and then transmit (single-user, SU) data frames. The stations may also use a multi-user (MU) scheme in which a single station, usually the AP 110, is allowed to schedule a MU transmission, i.e. multiple simultaneous transmissions to or from other stations, in the wireless network. One implementation of such a MU scheme has been for example adopted in IEEE Std 802.11ax-2021 standard, as the Multi-User Uplink and Downlink OFDMA (MU UL and DL OFDMA) procedures.

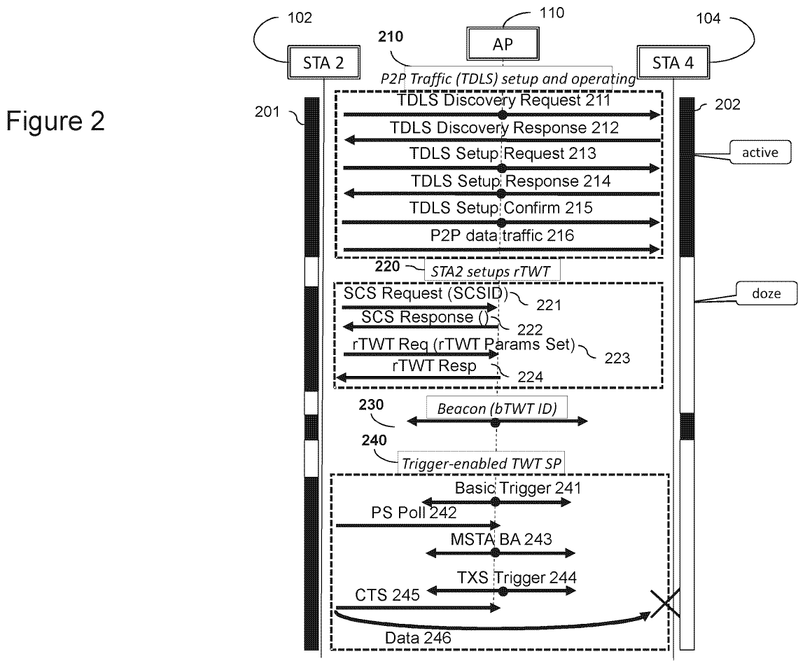

FIG. 2 illustrates, using frame exchanges in a timeline, a possible scenario for an initiator peer non-AP STA to handle P2P traffic.

This example involves STA 2 102 as the initiator for the P2P communication and STA 4 104 as the partner for the P2P communication. They both take part of the same BSS on a given link, and are associated with AP 110. The two non-AP stations take part of a same BSS on a given link: they have discovered and registered with AP 110. As mentioned above, STA 2 and STA 4 may be non-AP stations affiliated to respective non-AP MLDs, while AP 110 may be an AP affiliated to an AP MLD.

In the Figure, the vertical state bands 201 and 202 show the states of STA 2 and STA 4 over time, respectively, hence their activity. The black portions of the bands represent the active (or awake) state of the corresponding station, while the white portions represent the doze (sleep) state. Conventional mechanisms are known to switch from one state to the other. For example, a station in the doze state usually wakes up (switched to the active state) at beacon times to receive the beacon frames.

In the sequence, once STA 2 and STA 4 are associated with the AP (association not shown), they can exchange data over their operation link (phase 210).

For example, a P2P session can be opened (WiFi-Miracast, TDLS, etc.) during phase 210.

As a legacy P2P mechanism remaining considered in 802.11, Tunneled direct-link setup (TDLS) is characterized by the use of signaling frames that are encapsulated in Data frames so that the signaling frames are transmitted through the AP transparently. Therefore, the AP does not need to be direct-link aware, nor does it have to support the same set of capabilities that are used on the direct link, in order for TDLS to be used.

In the sequence shown, a TDLS session or “TDLS direct link” is established between STA 2 and STA 4 (either of both can be the initiator of the establishment). The establishment may include a TDLS discovery (option) and a TDLS setup. At that time, both STA 2 and STA 4 are in the active state.

TDLS discovery and setup between STA 2 and STA 4 involve frames that are usually sent and received via intermediate AP 110. The TDLS procedure is characterized by encapsulating signalling frames in 802.11 Data frames, which allows them to be transmitted through the AP transparently.

When attempting to discover TDLS stations in the same BSS, a series of frame exchanges is used. STA 2, which is the initiator in the proposed scenario, sends a TDLS Discovery Request frame 211, tunneled through AP 110, to an individual destination station, here STA 4. This request frame conveys a Link Identifier element including a BBSID field, a TDLS initiator STA address field and a TDLS responder STA address field. The BSSID field is set to the BSSID of the BSS of which initiator STA 2 is a member. The TDLS initiator STA Address field is set to the TDLS initiator STA's MAC address, hence the one of STA 2. The TDLS responder STA Address field is set to the TDLS responder STA's MAC address, hence the one of STA 4. Destination station STA 4 responds with a TDLS Discovery Response frame 212 directly to STA 4 (without relay by AP 110).

When attempting to establish a TDLS direct link over a single link with the discovered TDLS station, a series of frame exchanges is used to set up a TDLS link. Initiator STA 2 (TDLS initiator) first sends a TDLS Setup Request frame 213, tunneled through AP 110 (relay illustrated by the black dot), to target partner STA 4 (TDLS responder). This frame includes information about the capabilities of initiator STA 2 and an AID thereof. Target partner STA 4 responds with a TDLS Setup Response frame 214, also tunneled through AP 110, including information about its capabilities, its AID plus a status code that either accepts or rejects the setup request. If the Setup Request is accepted, initiator STA 2 then sends a confirmation, TDLS Setup Confirm frame 215, via AP 110. This concludes the TDLS setup handshake. At this point, the two stations know the identity of the other on the one hand with the MAC address and on the other hand with the AID.

The stations can then start to communicate directly: P2P traffic 216 can then be directly (not black dot shown at the AP in the Figure for arrow 216) exchanged between STA 2 and STA 4 using the established TDLS session. A TDLS peer is then configured to accept Data frames received directly from the other peer. The frame exchanges are performed over the same link, that is to say the same frequency channel so that this P2P traffic becomes concurrent to other traffic for AP.

The discovery procedure may also rely on scan procedure on predefined band with a listen and a search state as described for WiFi-Miracast. This discovery procedure also makes it possible to get the identities of the peer STAs.

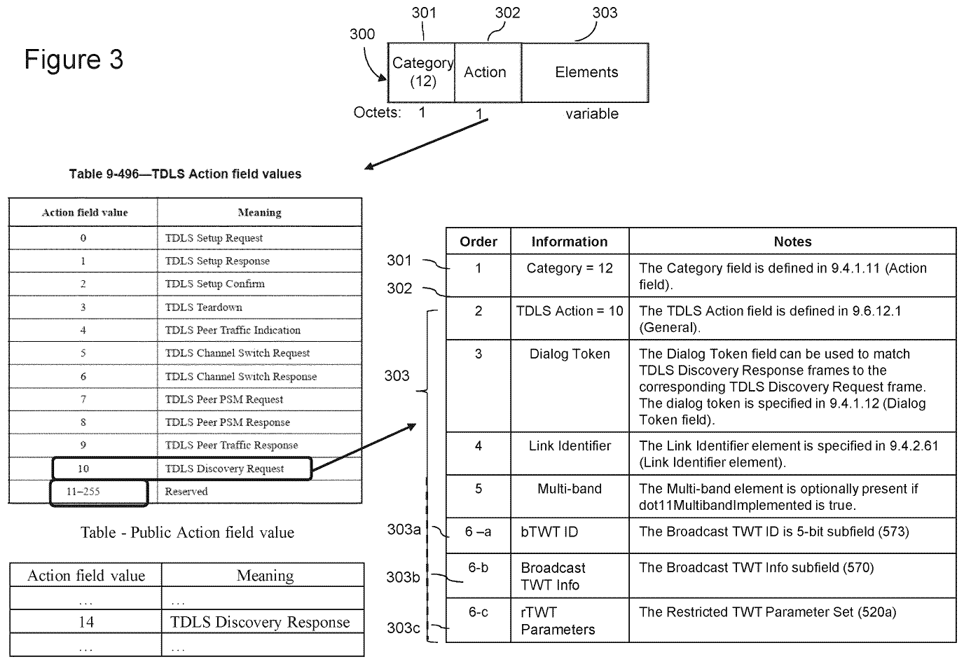

Details on the TDLS procedure are provided in IEEE 802.11z, and have been upgraded to be established over one link among possibly multiple links as provided in the D1.5 standard. With reference to FIG. 3, the data payload of a TDLS frame is shown under reference 300.

Data payload 300 has the format of a frame, hence having a Category field 301, an Action field 302 immediately after the Category field 301 and an Elements field 303.

Various values of the Category field 301 are defined in the 802.11 standard, corresponding to various Actions frames. Category field set to 12 defines a TDLS Action frame, while Category field set to 4 defines a Public Action frame.

TDLS Action frames conveys TDLS signalling.

1-byte Action field 302 for a TDLS Action frame may take various values from 0 to 10 (11 to 255 being reserved), as shown in Table 9-496 of the 802.11 Standard (as example, IEEE P802.11-REVme™/D1.0, December 2021 provides the latest allocation for those standardized values), corresponding to various signalling. For example, TDLS Setup Request frame 213 can be identified by Action field 302 set to 0; TDLS Setup Response frame 214 by Action field 302 set to 1; and TDLS Setup Confirm frame 215 by Action field 302 set to 2.

For illustrative purposes, Table 9-501 of the 802.11 Standard reproduced in FIG. 3 shows the elements 303 to be provided for TDLS Peer Traffic Indication frame (Action field 302 set to 4). Each type of TDLS Action frame has its own set of elements 303 to be provided (defined in the standard).

Similarly, 1-byte Action field 302 for a Public Action frame may take various values from 0 to 45 (46 to 255 being reserved). For example, TDLS Discovery Response frame 211 can be identified by Action field 302 set to 14.

Back to FIG. 2, initiator STA 2 may wish to take benefit of enhanced services provided by AP 110 that are related to low latency traffics from real time applications that have stringent latency requirements. These include the Stream Classification Service (SCS) mechanism and the Restricted Target Wake Time (rTWT) mechanism.

To meet low latency requirements in EHT as well as to increase efficiency of the MU UL operation, the Stream Classification Service (SCS) mechanism, originally defined in the IEEE/802.11aa standard, has been proposed to be used as a light-weight mechanism for a non-AP station to inform the AP of its QoS requirements, especially for low-latency traffics.

Low latency reliable services, LLRS, are services provided to a higher layer traffic stream that prioritize and deliver MSDUs within a worst-case latency budget with a given reliability/packet delivery ratio (PDR) and low jitter. Traffic that may be concerned by LLRS includes latency sensitive data, i.e. data from applications such as gaming, media streaming, augmented reality, virtual reality, and so on.

Originally, the SCS mechanism allowed the establishment of traffic streams with higher layer signalling of packet drop eligibility (e.g. allowed some packets in the traffic stream to be tagged as drop eligible) and allowed classification of traffic streams into an access category, using TCLAS—Traffic CLASsification—processing.

The typical scenario of using SCS consisted in working with local traffic streams, wherein subsequently the SCS mechanism provides signalling for selecting some packets (drop-eligible ones) in the traffic streams with a view of discarding them in case of insufficient channel capacity. In short, the SCS mechanism aims to differentiate between separate traffic streams within the same access category or the same TID, and covers the need to allow for the graceful degradation of the traffic stream in case of bandwidth shortage.

The SCS mechanism has been adapted to the ML context. As shown in the D1.5 standard, a Multi-Link SCS procedure is now provided in the context of robust audio-video streaming. Like in IEEE 802.11aa, the Multi-Link SCS procedure provides SCS Request frames, either to create/add, modify, or delete a SCS stream, and corresponding SCS Response frames. A SCS stream is defined in those SCS Request frames through a so-called SCS descriptor, and is identified by a SCS identifier, SCSID, in the SCS Response frames.

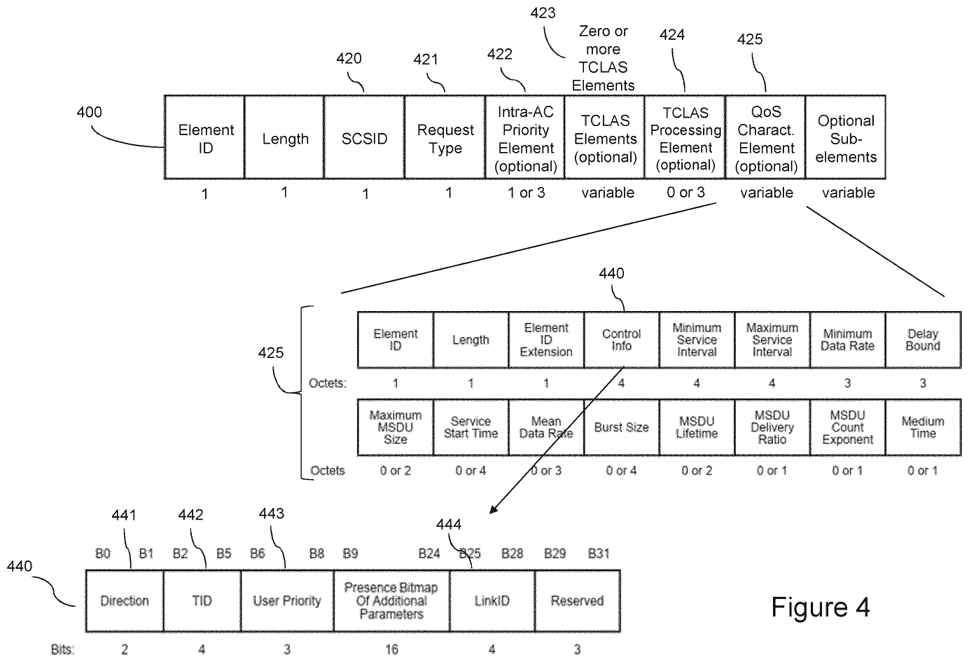

FIG. 4 illustrates the SCS descriptor included in those SCS frames. It includes:
SCSID field 420. Each traffic stream is assigned an ID by an affiliated non-AP station requesting classification. This ID, named SCSID 420, is unique across the non-AP MLD, because it is managed at MLD level;
Request Type field 421 takes a value to identify the type of SCS request: Add, Remove, or Change;
Optional Intra-Access Category Priority element 422 provides information to the AP MLD on the relative priorities of the SCS traffic streams within an AC. It corresponds to the optional introduction of two alternate queues proposed by the IEEE 802.11aa standard, compared to the four primary queues of EDCA;
TCLAS Elements 423 and TCLAS Processing Element 424, if present, describe the criteria for traffic classification the non-AP MLD requests the AP MLD to apply to identify the data or MSDUs forming the corresponding SCS stream. These elements are mandatory for downlink direction (traffic from the AP MLD to the non-AP MLD), but are forbidden in the current standard for other directions (UL or for direct link); and
a Traffic Specification, called QoS Characteristics Element 425. QoS Characteristics Element field 425 contains zero or one QoS Characteristics element to describe the traffic characteristics and QoS expectations of traffic flows that belong to this SCS traffic stream.

The QoS Characteristics are considered by the AP MLD or AP to properly schedule the non-AP MLD or non-AP station to transmit the local SCS stream. As an example, the AP MLD may enable the transmission of frames from the non-AP MLD with an interval that falls between the requested minimum and maximum service intervals and the AP MLD may meet the minimum data rate requested if the Direction subfield of the QoS Characteristics element indicates uplink or direct-link.

As shown in the Figure, various fields are provided in QoS Characteristics element 425 that define various QoS transmission parameters for the local SCS stream.

Control Info field 440 within QoS Characteristics element 425 is defined as follows:
Direction subfield 441 specifies the direction of data forming the stream: Uplink (field set to 0), Downlink (1) or Direct-link (2).
TID subfield 442 contains the target TID value of the MSDUs belonging to the local SCS stream (i.e. as described by the SCS Descriptor 400). In practice, this TID can then be used by the AP MLD or AP to schedule (e.g. polling Buffer status reports, allocating resources in emitted trigger frames) the SCS stream, rather than using the SCSID.
User Priority subfield 443 contains the UP (value 0-7) of the data frames that are described by this element. When the TCLAS element 424 is present in the SCS frame containing this element, the User Priority subfield is set to the user priority value specified in the TCLAS element,
LinkID subfield 444 contains the link identifier of the link for which the P2P or direct link transmissions are going to occur (therefore only considered when Direction subfield 441 specifies Direct-link).

Other subfields of QoS Characteristics element 425 are of less importance for the present invention; they represent the set of parameters defining the characteristics and QoS expectations for the SCS stream (e.g. Minimum and Maximum Service Intervals, Minimum Data Rate, Delay Bound).

In the illustrative sequence of FIG. 2, initiator STA 2 creates an SCS stream with AP 110, using SCS Request frame 221 that contains a QoS Characteristics element 425 (inside the SCS Descriptor 400) of its P2P traffic, in which the Direction subfield 441 is set to Direct link (value 2). At that time, STA 2 is in the active state, while STA 4 which does not communicate is in the doze state. AP 110 responds with SCS Response frame 222.

The recently introduced SCS mechanism introduced for the EHT standard remains a light-weight protocol for a non-AP MLD (or station) to inform the AP MLD (or AP) of its QoS requirements. As already told, the AP MLD may use any link to convey the SCS stream: any of its affiliated AP can trigger communication of the SCS data via the corresponding affiliated STA of a non-AP MLD. For P2P communication, the used Link is specified by LinkID subfield 444.

SCS streams, because they are used especially for low-latency traffics, are privileged candidates for the Restricted Target Wake Time (rTWT). That is why the SCS stream creation (221, 222) may start a more general phase (220) related to setting up rTWT.

rTWT is based on the Target Wake Time (TWT) mechanism originally defined in the IEEE 802.11ah/ax standards to allow devices to determine when and how frequently they will wake up to send or receive data. TWT allows an AP to manage activity in the network, in order to minimize medium contention between STAs, and to reduce the required amount of time that a STA in the power-save mode on a Link needs to be awake. Thanks to this mechanism, a STA of a non-AP STA MLD can doze except during the TWT service period (SP) intervals setup on this link.

802.11be provides TWT with enhanced medium access protection and resource reservation, called restricted target wake time (r-TWT or rTWT), typically in the scope of servicing latency sensitive traffic. An r-TWT agreement is established using the same procedure used to set up a Broadcast TWT agreement (introduced in IEEE Std 802.11ax-2021), except that the TWT setup frames contain a Broadcast TWT element that includes a Restricted TWT Parameter Set field as described here below.

A non-AP station establishes membership in broadcast TWT schedules of the AP, while the AP delivers broadcast TWT parameter sets to the non-AP stations. The non-AP station is said to be the TWT scheduled station, while the AP is said to be the TWT scheduling station.

Negotiations to become a member of or terminate membership in an rTWT schedule (more generally a broadcast TWT) are performed with an exchange of frames that carry TWT elements as shown below, having the Negotiation Type subfield set to 3 (Broadcast TWT). In particular, a non-AP STA MLD may request to become a member of an rTWT schedule by transmitting a TWT Request frame to its associated AP MLD that contains a TWT element for a given rTWT schedule.

The AP then advertises the scheduled rTWT using broadcast TWT elements in its management frames, typically in the beacon frames, FILS Discovery frames and broadcast Probe Response frames.

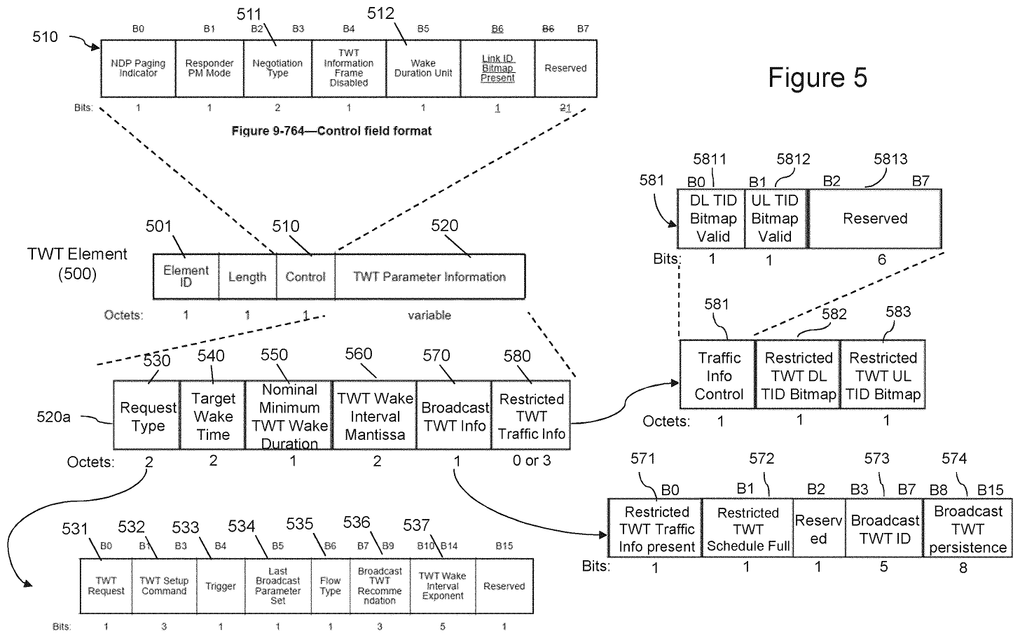

FIG. 5 illustrates a format of a TWT element 500 adapted to be used for r-TWT according to the D1.5 standard.

TWT element 500 is identified by an Element ID 501 and comprises “Control” field 510 and field 520 for transporting TWT parameter information.

“Control” field 510 allows informing through a “Negotiation Type” field 511 whether the TWT is a broadcast TWT or an individual TWT agreement. The MSB of the Negotiation Type subfield 511 is the Broadcast field, therefore the TWT element 500 is referred to as Broadcast TWT element when MSB of subfield 511 is 1. Other fields are of less importance for present description.

“TWT Parameter Information” field 520 contains a single ‘Individual TWT Parameter Set’ field if individual TWT (not shown), and one or more ‘Broadcast TWT Parameter Set’ fields having format 520a shown in the Figure if Broadcast TWT (when Broadcast field of the “Negotiation Type” subfield is 1).

First field in “Broadcast TWT Parameter Set” field 270a is Request Type field 530 comprising:
TWT Request subfield 531 set to 1 when issued by the TWT scheduled STA. Otherwise, set to 0 by the TWT scheduling STA (AP);
TWT Setup Command subfield 532 to indicate the type of TWT command: Request, Suggest, Demand, Reject when issued by a non-AP STA; or Accept, Alternate, Dictate, Reject when issued by a TWT scheduling AP;
Trigger field 533 to indicate whether or not the TWT SP indicated by the TWT element 500 includes triggering frames (the Trigger subfield equals to 1 for r-TWT, for trigger-enabled). Such a TWT SP is named trigger-enabled TWT SP, and no non-AP station cannot start transmitting data within it without previous triggering by the AP;
Broadcast TWT Recommendation field 536 set to 4 to indicate the TWT described in Broadcast TWT element 500 is a restricted TWT (r-TWT). In that case, Broadcast TWT element 500 is also referred to as a restricted TWT element (r-TWT IE), while Broadcast TWT Parameter Set 520a is referred to as Restricted TWT Parameter Set.
Other subfields are of less importance:
   Last Broadcast Parameter Set subfield 534 is set to 0 to indicate that another Broadcast TWT Parameter set follows this set. The Last Broadcast Parameter Set subfield is set to 1 to indicate that this is the last broadcast TWT Parameter set in the broadcast TWT element.
   Flow Type subfield 535 indicates whether the TWT is announced (the TWT scheduling AP will wait to receive a frame from TWT scheduled STA to signal its awake state) or not (Flow Type subfield equals to 0 for r-TWT, for “announced” mode, because r-TWT is a trigger-enabled TWT).

Other fields in Restricted TWT Parameter Set field 520a are used to define time Parameters for the rTWT schedule, as follows:
Target Wake Time (TWT) field 540 indicates the next time (in microseconds) at which the station participating in the rTWT schedule should wake up for the next rTWT SP;
Nominal Minimum TWT Wake Duration field 550 indicates the minimum amount of time that the TWT scheduled STA is expected to be awake since the starting time of the TWT SP in order to complete the frame exchanges for the period of TWT Wake Interval. The TWT Wake Interval of the rTWT SP is the value calculated from the TWT Wake Interval Mantissa 560 and TWT Wake Interval Exponent 537. It is expressed in number of units as defined in Wake Duration Unit subfield 512 of Control field 510, e.g. typically 256 μs.

Other fields in Restricted TWT Parameter Set field 520a are used to define Parameters specific to the Broadcast and Restricted nature of the rTWT SP:
Broadcast TWT Info field 570.
   It conveys the identifier of the rTWT schedule, namely the Broadcast TWT ID 573 (bTWT ID), that is used to identify the rTWT SPs belonging to the same rTWT schedule. This identifier, which is not 0, hence allows an AP to schedule multiple sets of Broadcast TWT SPs with different sets of TWT parameters;
   It specifies, through Broadcast TWT Persistence subfield 574, the number of Target Beacon Transmission Times (TBTT) during which the Broadcast TWT SPs corresponding to this Restricted (more generally Broadcast) TWT Parameter set are present;
   It also signals, through Restricted TWT Schedule Full subfield 572, when set to 1, that the r-TWT scheduling AP is unlikely to accept a request from a STA in the BSS to establish a new membership in the corresponding schedule (identified by bTWT ID 573);
   Finally, it also signals, through Restricted TWT Traffic Info Present field 571, whether Restricted TWT Traffic Info field 580 is present (field 571 to 1) or not.
Restricted TWT Traffic Info field 580 specific to the restriction of the Broadcast TWT-to specific traffics. This field is mandatory (hence field 571 is mandatorily set to 1) when the broadcast TWT is related to an SCS LL stream (otherwise, the Traffic Info is related to TIDs).
   It comprises Traffic Info Control field 591 that indicates whether the following fields 582 and 583 are provided (i.e. “valid”). DL TID Bitmap Valid subfield 5811 (respectively UL TID Bitmap Valid subfield 5812) indicates whether the Restricted TWT DL TID Bitmap field 582 (respectively Restricted TWT UL TID Bitmap field 583) has valid information.
   Restricted TWT DL TID Bitmap field 582 (respectively Restricted TWT UL TID Bitmap field 583) identifies TIDs as latency sensitive traffic for DL (respectively UL) directions, i.e. TIDs that are allowed in the rTWT defined by Restricted TWT element 500. The TIDs may be those defining SCS streams. A value of 1 at bit position k in the bitmap indicates that TID k is classified as latency sensitive traffic stream for the concerned transmission direction.

The TWT SP of an rTWT schedule is uniquely identified by the <bTWT ID, MAC address of TWT scheduling AP> tuple.

In the illustrative sequence of FIG. 2, initiator STA 2 requests AP 110 to become an r-TWT scheduled STA, by negotiating r-TWT SPs (TWT Request frame 223) for its low latency traffics, to which the P2P traffic with STA 4 belongs. For example, initiator STA 2 may negotiate the wake TBTT, wake interval and the SCS streams to be allowed in the rTWT. AP 110 provides a TWT Response frame 224 accepting or refusing the request. In other words, STA 2 requests membership in an rTWT schedule.

TWT Request frame 223 carries TWT elements with the Negotiation Type subfield 511 set to 3 and the TWT Setup Command field 532 set to Request TWT, Suggest TWT, or Demand TWT. The Restricted TWT Parameter set 520a indicates the Broadcast TWT ID 573 of the rTWT schedule that the STA is requesting to join. The AP has possibility to answer (TWT Response frame 224) with no new rTWT schedule for the bTWT ID (keep existing one), or offering an alternative set of parameters to those indicated in TWT Request frame 223, or creating a new rTWT schedule with a new bTWT ID.

Once the negotiation and membership completed, rTWT scheduled STA 2 that is in awake state may enter, thanks to the advertising of the rTWT SPs (e.g. through beacon frames 230), the doze state after receiving a Beacon frame with a Restricted TWT element indicating the existence of an rTWT schedule and switch back to the awake state at the rTWT SP start times. The Beacon frame indicates an rTWT SP during which the TWT scheduling AP intends to send Trigger frames, or DL BUs to the TWT scheduled STAs.

As a result, both STA 2 and STA 4 receive Beacon frame 230, but only STA2 that has negotiated the rTWT schedule (and in member thereof) will decode such periods of activity. Only STA2 will be awake for the rTWT SP 240.

It is often recommended that the TWT scheduling AP receives any indication that the TWT scheduled STA is in the awake state within that rTWT SP (see Flow Type subfield 535), because it may be in the doze mode just before the rTWT SP starts. A specific procedure is implemented based on a trigger frame sent by the TWT scheduling AP. Hence, TWT scheduling AP 110 ensures that a trigger frame 241 (e.g. PS-Poll Trigger frame) is scheduled at the start of the rTWT SP 240, in response to which the TWT scheduled stations (here STA 2) can advertise of its awake state (e.g. PS-Poll frame 242). TWT scheduling AP 110 can block-acknowledge (243) the PS-Poll frames 242 to multiple TWT scheduled stations.

Being aware of the TWT scheduled stations in the awake state, TWT scheduling AP 110 uses OFDMA Multi-User techniques (e.g. MU UL trigger-based transmission, MU DL transmission) to manage the rTWT SP and possibly offer resource units to all or part of the TWT scheduled stations in the awake state.

As example, within such a trigger-enabled rTWT SPs, the Triggered TXOP Sharing (TXS) mechanism may be used, sending a MU RTS TXS trigger frame 244 to allocate a portion of the time within the TXOP (obtained through the trigger frame) to one of the TWT scheduled stations in the awake state, here STA 2, for transmitting data.

An Allocation Duration subfield in the MU-RTS TXS Trigger frame 244 indicates the time duration allocated to STA 2 within the TXOP obtained by TWT scheduling AP 110 with the rTWT SP 240. There is only one User Info field and it is addressed to STA 2 (i.e. AID12 subfield is set to a value between 1 and 2006 that corresponds to STA2 AID in this example). A specific information inside MU-RTS TXS Trigger frame 244 is the TXOP Sharing Mode subfield, which is set to 2 to indicate a possible P2P data to be transmitted. Therefore, the rTWT mechanism allows a P2P transmission to take place within the rTWT SPs, that is triggered using the TXS mechanism.

If in response to transmitted MU-RTS TXS Trigger frame 244, STA2 transmits one or more non-TB PPDUs within the time allocation signalled in the MU-RTS TXS Trigger frame, the first PPDU of the exchange sent by STA 2 is a CTS frame 245.

During the time allocated by TWT scheduling AP 110, TWT scheduled STA2 can transmit non-TB PPDUs 246 to the AP (not illustrated in the figure) or to another STA (typically STA 4 for P2P traffic) if the TXOP Sharing Mode subfield value is 2.

Unfortunately, as shown by state band 202, STA 4 which is not member of the rTWT schedule negotiated by its partner peer STA has no necessity (by its own knowledge) to be awake during that period. It is therefore in the doze state, and unable to receive P2P data from STA 2.

The P2P data are still transported, with is time consuming, and the session will terminate after a timeout (because no acknowledgment is received back).

In addition, the time used to these missed data is detrimental to other stations participating to rTWT SP 240, because this time resource is rare (low latency streams).

As a result, P2P traffic at the non-AP station continuously requests resource allocation in rTWT schedules that is never profitable to it (a peer is missing) and no longer profitable to other AP operations.

The exemplary scenario of FIG. 2 shows that the SCS, TDLS, rTWT and TXS mechanisms can work in combination. They advantageously allow the latency sensitive streams to be clearly identified (SCS), and full channel (TXS) in dedicated transmission windows (rTWT) to be reserved for them. However, the resulting overall mechanism is still deficient to properly handle P2P (or DiL) latency sensitive streams.

To facilitate P2P transmissions within a restricted Target Wake Time, rTWT, schedule, an AP of a BSS that has established membership of a peer station in the rTWT schedule and that detects P2P traffic between the peer station and a partner peer station of the BSS, may notify the partner peer station about the existing rTWT schedule. The AP may further invite the peer stations to establish a Direct Link communication session. The notification may be included in said invitation or be carried through an unsolicited TWT frame enrolling the partner peer station in the rTWT schedule. It turns out that the partner peer station now wakes up for the service periods of the rTWT schedule, hence facilitating the direct or relayed transmission of P2P data within one and the same service period.

It is sought to efficiently notify the partner peer non-AP station of the BSS, STA 4 in the scenario, about the rTWT schedule negotiated between the initiator peer non-AP station, STA 2, and the AP of the BSS. This is of course for the partner peer STA 4 to be awake for the rTWT SP of the rTWT schedule, hence to be available for P2P communication with initiator peer STA 2.

Embodiments of the invention are based on the ability of the AP to determine that P2P data are exchanged between the two peers and consequently to notify the peer not yet member of the rTWT schedule, about that rTWT schedule. The notification of the rTWT schedule allows partner peer STA 4 to obtain the rTWT timing parameters and the like from the Management frames (e.g. Beacon frames 230) sent by the AP. Partner peer STA 4 can therefore awake at the appropriate time of rTWT SP 240 to receive (or exchange) P2P data 246 with initiator STA 2 within this service period.

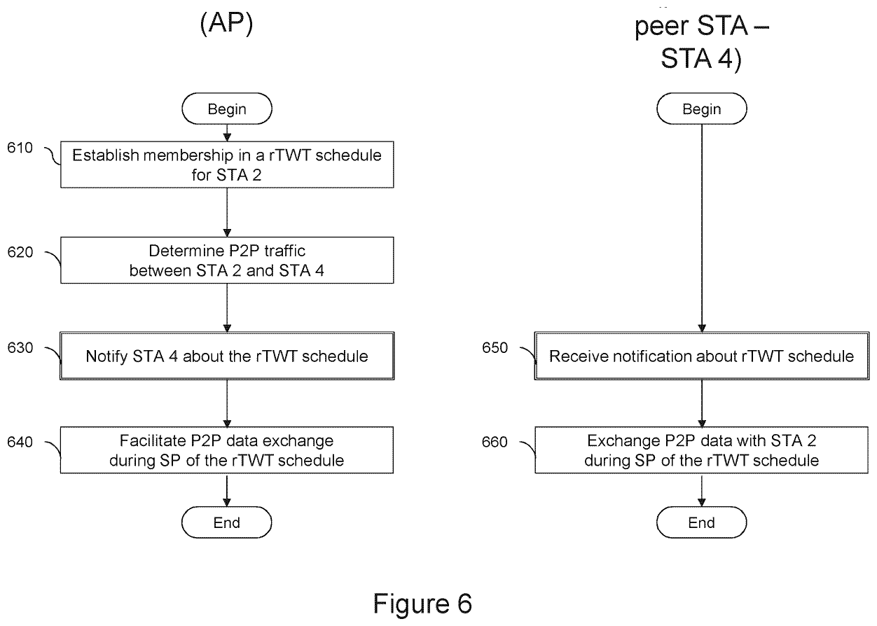

FIG. 6 illustrates, using flowcharts, exemplary steps at the AP MLD (or AP) and one of the peer MLDs (or stations) according to some embodiments of the invention.

The peer MLDs are assumed to be associated with the AP MLD, hence belonging to the same BSS, before the process starts. The left part of the Figure represents steps at the AP, while the right part represents steps at the peer non-AP station not yet member of the rTWT schedule of which the other peer non-AP station is member.

For the sake of illustration, the STA 2 may take the role of initiator peer STA, or in other words, the role of TDLS initiator STA. The STA 4 may take the role of partner peer STA, or in other words, the role of TDLS responder STA.

In embodiments (as described here below), the TDLS initiator STA acts also as the TWT scheduled STA with the TWT scheduling AP. Alternatively, the TDLS responder STA may act as a scheduled STA to negotiate an rTWT schedule with the TWT scheduling AP.

At step 610, an rTWT agreement is established between initiator STA 2 and the AP, including for STA 2 to request membership in the rTWT schedule and negotiating corresponding Restricted TWT Parameter Set. This step corresponds to phase 220 of FIG. 2 described above. This results in having initiator STA 2 being member of an rTWT (broadcast TWT) schedule identified by a bTWT ID.

Next, at step 620, the AP determines that initiator STA 2 and a second peer non-AP station of the BSS, peer STA 4 in the example, have P2P data traffic to exchange. This step allows the AP to identify (e.g. with an AID or MAC address) peer STA 4.

As shown in some embodiments further on in the description, steps 610 and 620 can be inverted, in particular when the AP relays Setup frames exchanges between the two peers to setup a P2P session, in which case the identification of P2P needs can be made prior the establishment of membership in the rTWT schedule.

Responsive to such determining, at step 630, the AP notifies peer STA 4 about the rTWT schedule, e.g. by transferring at least the bTWT ID of the rTWT schedule to peer STA 4. This allows the AP to enrol STA 4 in the rTWT schedule.

In some embodiments, the notification may consist in establishing membership of peer STA 4 in the rTWT schedule, e.g. by sending, to peer STA 4, an unsolicited TWT Setup frame signaling the rTWT schedule, using for instance a Restricted TWT Parameter Set subfield including the bTWT ID of the rTWT schedule. Embodiments of this scenario are described with more details below with reference to FIGS. 6, 7, 8, 11, 12, 13, 14, 16 and 17.

In some embodiments, the notification may be included in an invitation from the AP to establish a P2P session with peer STA 2, e.g. by sending, to peer STA 4, an unsolicited TDLS Discovery Request frame on behalf of STA 2. Embodiments of this scenario are described with more details below with reference to FIGS. 6, 13, 15, 16 and 17.

The notification about the rTWT schedule in these TDLS frames may include information about the bTWT ID identifying the rTWT schedule, for example providing only bTWT ID as TWT information, hence reducing overhead while providing simplicity to signal the rTWT SPs. This corresponds to the addition of 5-bit subfield 573 in the TDLS frames. However, more TWT information may be provided. For example, the notification may include a Broadcast TWT Info subfield (reference 530) including bTWT ID, or even a Restricted TWT Parameter Set subfield (reference 520a) including bTWT ID.

The notification may also signal an identifier of the other peer, here STA 2, so to help STA 4 in its decision to effectively accept joining the rTWT schedule. It is noted that STA 4 may refuse membership in the rTWT schedule by responding with a TWT Teardown frame or a TWT response with TWT Setup Command field indicating Reject TWT. This aims at withdrawing from the unsolicited Broadcast TWT schedule. It may alternatively refuse establishing the P2P session suggested by the AP in case of an invitation.

Correspondingly, STA 4 receives the notification (including bTWT ID) at step 650. Therefore, STA 4 can now identify the rTWT SPs of the rTWT schedule, as advertised in Management frames sent by the AP.

Next, at step 640, the AP facilitates P2P data exchange between STA 2 and STA 4 within the service periods of the rTWT schedule. This may include sending Management frames (e.g. Beacon frames 230 in FIG. 2) and then providing opportunities, within the rTWT SPs, for the peer stations to send their P2P data, in particular to ensure the P2P data are received by the other peer within the same rTWT SP.

In embodiments, the P2P data transmission may be direct between STA 2 and STA 4. For example, the AP may allocate one of the peers, e.g. STA 2, with a portion of the time of the rTWT SP using the TXS mechanism, so that STA 2 directly sends its P2P data to STA 4. Embodiments of this scenario are described with more details below with reference to FIGS. 6, 7, 8, 13, 14, 15, 16 and 17.

In other embodiments, the P2P data transmission between STA 2 and STA 4 may be relayed by the AP. For example, the AP may, after the notification, receive P2P data from one of the peers, e.g. STA 2, (usually in HE Trigger-Based PPDUs) and relay them to STA 4 (usually using HE MU PPDUs) within the same rTWT Service Period. Embodiments of this scenario are described with more details below with reference to FIGS. 6, 11, 12, 16 and 17.

Achieving the entire transmission of P2P data from STA 2 to STA 4 (or the reverse) within one and the same rTWT SP helps to minimize the two hops P2P communication latency in AP-centric BSSs.

Correspondingly, at step 660, STA 4 receives Beacon frame 230 from which it infers when it must be awake for the next rTWT SP of the notified rTWT schedule, and then exchanges, during the rTWT service period, P2P data with STA 2.

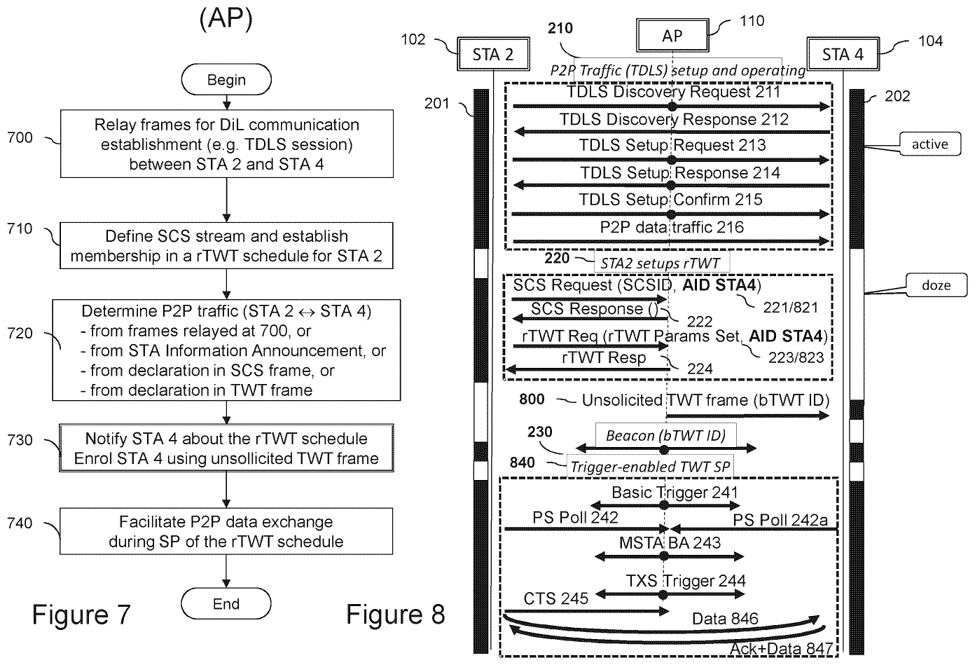

FIGS. 7 and 8 illustrate first embodiments where the two peer stations have established a DiL communication session prior to the AP notifying partner peer STA 4 of the rTWT schedule adhered by STA 2.

FIG. 7 illustrates, using a flowchart, exemplary steps at the AP according to these embodiments, while FIG. 8 illustrates, using frame exchanges in a timeline, the scenario of FIG. 2 when the AP notifies the partner peer about an rTWT schedule for P2P low latency traffic streams according to these embodiments. The same references as in FIG. 2 correspond to the same phases/steps/frames/entities.

As in FIG. 2, prior to establishing membership in the rTWT schedule for P2P purposes, the initiator peer non-AP station, STA 2, negotiates (phase 210) a Tunneled Direct Link Setup, TDLS, session with the partner peer non-AP station, STA 4, as described above (TDLS discovery and setup). Of course, in a variant, STA 4 may initiate the TDLS session.

Therefore, at step 700, AP 110 relays the TDLS Discovery Request frame 211, TDLS Setup Request frame 213, TDLS Setup Response frame 214 and TDLS Setup Confirm frame 215 between STA 2 and STA 4.

Still as in FIG. 2, initiator peer STA 2 sets up an rTWT schedule with scheduling AP 110 (phase 220) as described above (definition of SCS P2P streams—221-222, negotiation of the rTWT and establishment of membership therein—223-224).

Therefore, at step 710, similar to step 610, an rTWT agreement is established between initiator STA 2 and the AP, including for STA 2 to declare a SCS P2P stream (frames 221, 222) and to request membership in the rTWT schedule identified by bTWT ID (frames 223, 224).

During rTWT setup phase 220, initiator peer STA 2 may (optionally) signal the identity (e.g. AID) of its partner peer, STA 4.

In embodiments, such identity of STA 4 is signaled in the SCS Request frame (referenced 821 in FIG. 8), for example is included in the description of the transport characteristics of the P2P traffic declared through the SCS exchange.

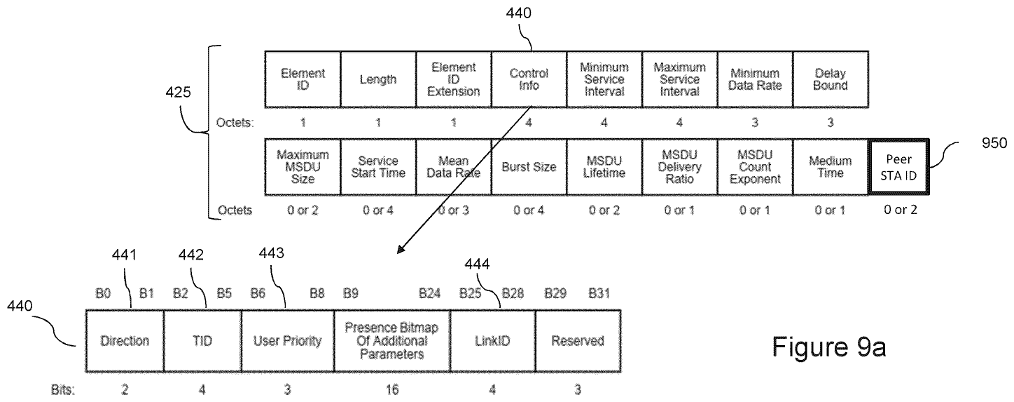

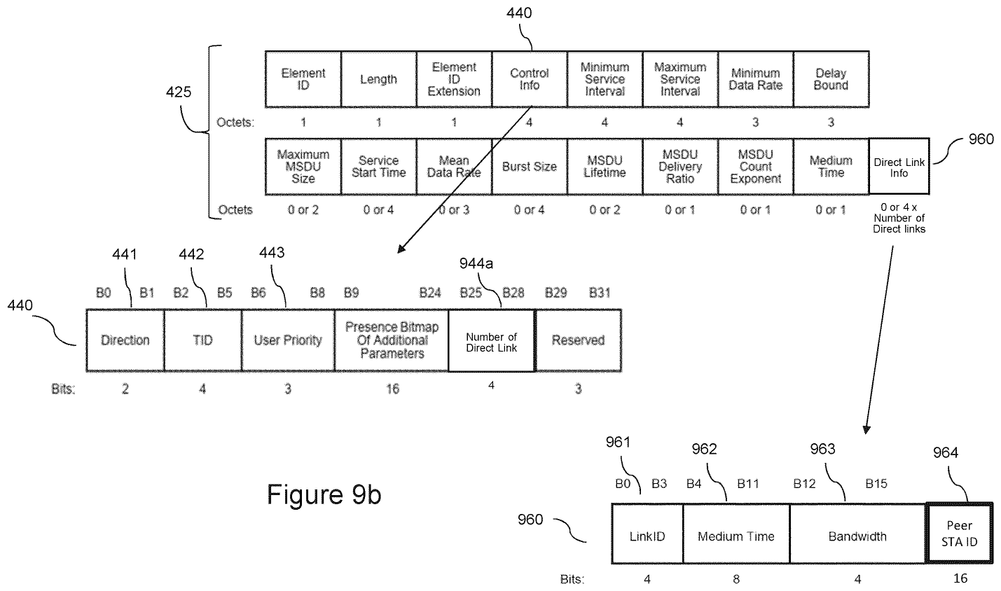

FIG. 9a illustrates the case where the AID of partner peer STA 4 is carried in an additional subfield to the QoS Characteristics element as defined in the D1.5 standard.

Modified QoS Characteristics element 425 now includes ‘Peer STA ID’ subfield 950 to carry such AID of STA 4.

The presence of this subfield may be conditioned to the value of the Direction subfield 441, i.e. the Peer STA ID subfield 950 is present if Direction subfield 441 is set to 2 (Direct-link); otherwise peer STA ID subfield 950 is absent. In the example of the Figure, Peer STA ID subfield 950 is 2-byte length as the length of the Association ID is. In the example of FIG. 7, the Peer STA ID subfield may be present to inform the AP that the traffic defined by the QoS characteristics element is a P2P traffic established between an initiator peer STA (STA 2) and its partner peer STA (STA 4). In other words, the presence of the Peer STA ID helps the AP to determine that a P2P traffic is established between an initiator peer STA (STA 2), the sender of the QoS characteristics element, and its partner peer STA (STA 4), the STA identified by the Peer STA ID. Thereby, in embodiments, the Peer STA ID subfield may be present to inform the AP that the traffic defined by the present QoS characteristics element should be directed to the STA identified by the Peer STA ID subfield.

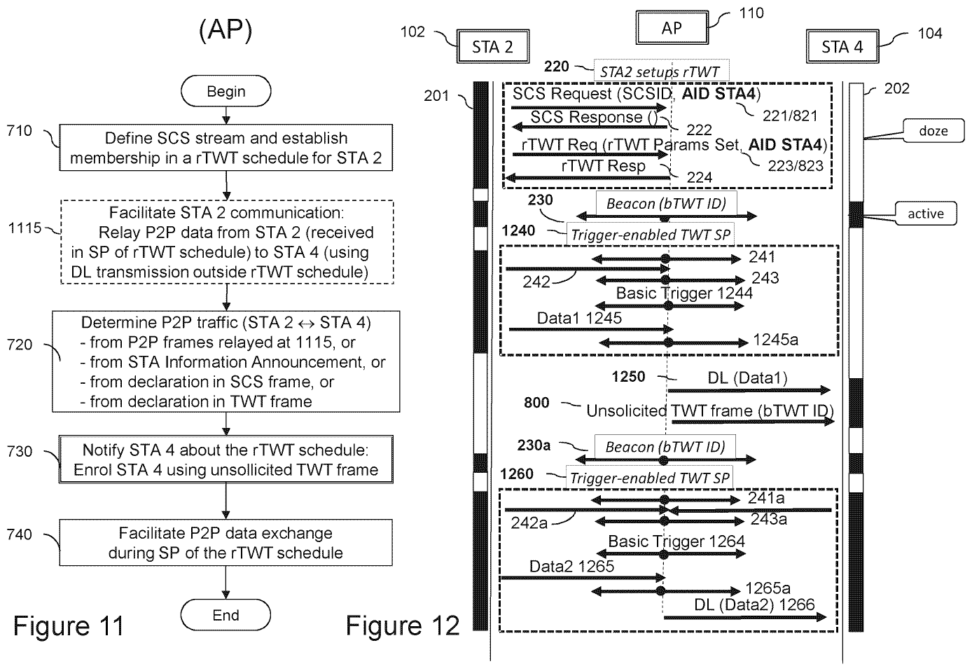

In alternative embodiments which may correspond to the case below where no P2P session is established between the two peers when defining the SCS streams (e.g. the scenarios of FIGS. 11 to 17), Peer STA ID subfield 950 may be present with a Direction subfield 441 set to (0) uplink to inform the AP that the uplink traffic defined by the QoS characteristics should be forwarded to a final destination STA identified by Peer STA ID subfield 950. Thereby, the AP infers that the traffic defined by the QoS characteristics and conveyed in a negotiated TWT will be part of a two hops P2P communication. In these embodiments, the Peer STA ID subfield may be present to inform the AP that the traffic defined by the present QoS characteristics element should be forwarded to a final destination STA identified by the Peer STA ID subfield.

FIG. 9b illustrates the case where the AID of partner peer STA 4 is carried in an additional subfield to the QoS Characteristics element as defined in contribution IEEE 802.11-22/0200r0 of January 2022.

This contribution aims at providing specification for P2P timeslots independently to the P2P protocol itself (TDLS or TXS). The proposed mechanism allows a STA to inform the AP of its QoS requirements, namely precise timeslot needs, for P2P traffics and further been granted a medium communication time. To do so, the QoS Characteristics element 425 is modified to include at least one new ‘Direct Link Info’ element 960 in replacement of the Medium Time subfield when the Direction subfield 441 is set to value 2 (Direct-link). The number of Direct Link Info elements is controlled by ‘Number of Direct Link’ subfield 944a present in the Control Info field 440.

In the contribution, Direct Link Info element 960 contains the following fields:
LinkID subfield 961 specifying the link identifier of the link that corresponds to the direct link for which the medium time and bandwidth are requested,
Medium Time subfield 962 containing an unsigned integer that specifies the medium time, in units of 256 microseconds, requested by the STA for direct link transmissions as the average medium time needed in each second, based on the bandwidth indicated in the Bandwidth field 963 for direct link transmissions and based on the assumption that all the direction link transmissions associated with this TID (subfield 442) were to take place only on this link specified in the LinkID subfield 961,
Bandwidth subfield 963 specifying the maximum bandwidth the STA can operate for direct link transmissions on the link specified in the LinkID subfield 961.

To signal the identity of STA 4, Direct Link Info element 960 is modified to further include Peer STA ID subfield 964 (similar to Peer STA ID subfield 950).

In alternative embodiments to the signaling of the identity of STA 4 in the SCS Request frame, such identity may be signaled in the TWT Request frame (referenced 823 in FIG. 8).

One option is to include any of the above QoS Characteristics elements of FIGS. 9a and 9b in TWT Request frame 823, either in replacement of the TWT element 500 or in addition to the TWT element.

Another option is to use a STA Information Announcement frame to indicate the identifier of partner peer STA4. The STA Information Announcement frame may be used by a non-AP STA to inform the AP of a partner peer STA's AID. The STA Information Announcement frame (specified in IEEE P802.11-REVme™/D1.0, December 2021 clause 9.6.24.5) includes AID Announcement element format which carries STA MAC Address and Association ID as defined in IEEE P802.11-REVme™/D1.0, December 2021 clause 9.4.2.208. The AP may infer that the AID announcement is related to partner peer STA when the MAC Address conveyed in the AID Entry field is different from the MAC address of the STA which transmits the frame. When the STA is involved in several P2P transmissions, the STA Information Announcement frame may include multiple entry fields, each one defining the MAC Address and AID of a different partner peer STA.

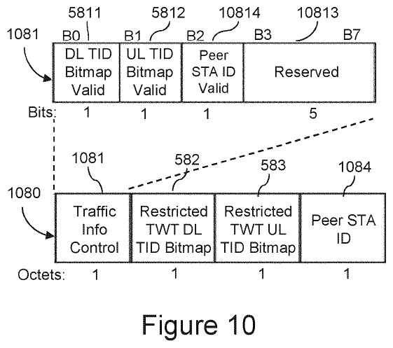

Another option as shown per FIG. 10 is to modify the TWT element 500 in TWT Request frame 823 to include the identifier of partner peer STA 4. In this case, the AID of partner peer STA 4 is carried in an additional subfield to the Restricted TWT Traffic Info field as defined in the D1.5 standard.

In the Figure, Restricted TWT Traffic Info field is updated as illustrated by 1080.

Restricted TWT Traffic Info field 1080 is composed of modified Traffic Control Info field 1081 that indicates whether the following fields 582, 583 and 1084 are valid.

Peer STA ID Valid subfield 10814 indicates whether Peer STA ID subfield 1084 is present and has valid information (the AID of STA 4 in the example). Of course, this subfield set as valid is only allowed when Direction subfield 441 of the QoS Characteristic element 425 that describes the traffic flow intended to take benefit from rTWT, specifies Direct-link (2) Direction. In addition, this information may be considered as related to direct-link when the DL TID Bitmap and UL TID Bitmap are not valid or set with all 0 values.

In an alternative embodiment, Restricted TWT Traffic Info field 1080 may also include a TWT P2P TID Bitmap subfield (not shown). Such Restricted TWT P2P TID Bitmap subfield may specify which TID(s) are identified by the TWT scheduling AP (e.g. under suggestion of the TDLS initiator STA acting as a TWT scheduled STA) as P2P latency sensitive traffic streams.

In alternative embodiments which may correspond to the case below where no P2P session is established between the two peers when defining the SCS streams (e.g. the scenarios of FIGS. 11 to 17), Peer STA ID subfield 1084 may be present with a Direction subfield 441 set to (0) uplink and a not-empty (value 0) UL TID Bitmap, to inform the AP that the uplink traffic defined by the QoS characteristics should be forwarded to a final destination STA identified by Peer STA ID subfield 1084. Thereby, the AP infers that the traffic defined by the QoS characteristics and conveyed in a negotiated TWT will be part of a two hops P2P communication.

After step 710, the AP determines, at step 720, that P2P data traffic exists between STA 2 and STA 4, and retrieves an identifier (AID or MAC address) of STA 4 which is not yet member of the rTWT schedule.

Detection of P2P data traffic can merely be made by detecting the TDLS frame exchange 210 and/or the presence of a Peer STA ID subfield 950, 964 or 1084 in SCS Request frame 821 or TWT Request frame 823 when implemented or the reception of a STA Information Announcement frame indicating partner peer STA information.

Correspondingly, the retrieval of STA 4's identifier may include one of the following:
retrieving one transmitter or destination MAC address of a MAC frame of P2P-related frame exchanged between the two peer non-AP stations. In the example, the TDLS frames relayed by the AP during the TDLS session setup phase 210 carry the MAC address of STA 4,
retrieving an AID of partner peer STA 4 from an rTWT Setup frame (e.g. rTWT Request frame 823) sent by peer STA 2 to establish its membership in the rTWT schedule. This works if Peer STA ID subfield 950, 964 or 1084 is provided in the TWT Setup frame,
retrieving an AID of partner peer STA 4 from a SCS Request frame (frame 821) sent by peer STA 2 to categorize a P2P traffic stream to be addressed to STA 4. This works if Peer STA ID subfield 950 or 964 is provided in the SCS Request frame, and
retrieving an AID of partner peer STA 4 from a STA Information Announcement frame sent by STA 2 to the AP to announce a partner peer. This operates when the MAC address conveyed in the AID Entry field is different from the MAC Address of the STA transmitting the STA Information Announcement frame.

Finally, at the end of step 720, the AP, being aware of partner peer's identity, may enrol partner peer STA 4 in the rTWT schedule by notifying it about the rTWT schedule adhered by STA 2. This is step 730.

As shown by reference 800 in FIG. 8, the AP may send an unsolicited TWT Setup frame which comprises identifier bTWT ID of the rTWT schedule adhered by STA 2. This is to establish membership of partner peer STA 4 in the rTWT schedule. Thanks to this establishment, the AP will be able to provide resources to both STA 2 and STA 4 within the service periods of that rTWT schedule.

Typically, bTWT ID is included in the Broadcast TWT Info subfield 530 of Restricted TWT Parameter Set subfield 520a within the TWT Element 500.

Preferably, the TWT scheduling AP sends an unsolicited TWT Response frame to the partner peer STA. The unsolicited TWT response frame 800 is sent with the Trigger subfield set to 1 if partner peer STA 4 supports Broadcast TWT schedules (i.e. STA 4 has set the Broadcast TWT Support subfield to 1 in the HE Capabilities elements that it transmitted to the AP upon association with the BSS). Thereby, in embodiments, when the AID of a partner peer STA is carried in the QoS Characteristics element, a TWT scheduling AP may enroll a partner peer STA in an rTWT schedule by notifying it about the rTWT schedule. To do so, the TWT scheduling AP sends an unsolicited TWT Response frame with the Trigger subfield set to 1 to the non-AP STA (partner peer STA) that has set the Broadcast TWT Support subfield to 1 in its HE Capabilities elements that it transmitted to the AP.

Various configurations for unsolicited TWT Response frame 800 may be contemplated.

In one configuration, TWT Response frame 800 indicates Accept TWT as value in TWT Setup Command subfield 532. Indeed, an unsolicited TWT Response frame with such a TWT Setup Command subfield allocates a broadcast TWT schedule (here rTWT schedule identified by bTWT ID carried in Broadcast TWT ID subfield 573) to the receiving station, here partner peer STA 4. A station, STA 4, that receives such unsolicited TWT Response frame may transmit a TWT Teardown frame or a TWT Response frame with TWT Setup Command subfield 532 indicating Reject TWT to withdraw from the unsolicited broadcast TWT schedule.

In another configuration, TWT Response frame 800 indicates Dictate TWT or Alternate TWT as value in TWT Setup Command subfield 532. Such an unsolicited TWT Response frame contains an advisory notification to the destination station, STA 4, of TWT parameters that are likely to be accepted by the AP if the destination station transmits a subsequent TWT Request frame to the AP that includes those TWT parameters. In that case, partner peer STA 4 has to send a TWT Request frame including the exact copy of the parameters supplied by the AP in the Dictate TWT or Alternate TWT frame 800.

In yet another configuration, TWT Response frame 800 indicates TWT Grouping or Demand TWT as value in TWT Setup Command subfield 532 or even indicated a new TWT command (by a new value in subfield 532), and their function is extended so that a P2P destination station understands it is a request from the AP to enroll it in a broadcast TWT for P2P transmission.

Whatever the configuration, the notification, here unsolicited TWT Response frame 800, also signals an identifier of initiator peer STA 2. This is to avoid or reduce risks that partner peer STA 4 rejects the TWT enrolment or proposal for rTWT membership due to a lack of information. Indeed, upon reception of unsolicited TWT Setup frame 800, STA 4 can then infer, from the identifier, that the rTWT enrolment tentative by the AP is in relation with an rTWT schedule in which STA2 has already membership and that a P2P transmission will occur during the service periods of the rTWT schedule (bTWT ID).

As examples, Peer STA ID subfield 950, 964 (if QoS Characteristics element 425 is included) or 1084 may be included in unsolicited TWT Response frame 800 to carry the identifier of initiator peer STA 2, typically its AID.

At the end of step 730, both peer stations, STA 2 and STA 4, have now established membership in the same rTWT schedule. They are now able to correctly wake up for the service periods of the schedule.

The TWT scheduling AP can now facilitate (step 740) P2P data exchange between STA 2 and STA 4 within the service periods of the rTWT schedule.

TWT scheduling AP 100 includes a broadcast TWT element in Beacon frame 230 that indicates the rTWT schedule (bTWT ID) during which the AP intends to allocate resources to either or both of STA 2 and STA 4. Both peer stations wake up to receive frame 230.

As shown in state band 202, partner peer STA 4 now wakes up at the beginning of service period rTWT SP 840 corresponding to bTWT ID.

In the scenario shown, TWT scheduling AP 110 still sends a PS-Poll Trigger frame 241 to be confirmed that initiator STA 2 is awake (PS-Poll frame 242 as a response). PS-Poll Trigger frame 241 may also trigger partner STA 4: PS-Poll frame 242a is sent as a response if STA 4 is awake. TWT scheduling AP 110 can block-acknowledge (243) the PS-Poll frames 242 to multiple TWT scheduled stations. This polling is however optional.

Next, TWT scheduling AP 110 sends a MU RTS TXS trigger frame 244 to allocate a portion of the time within the TXOP to initiator STA 2, which is acknowledged in response by STA 2 which sends a CTS frame 245. Alternatively, MU RTS TXS trigger frame 244 may allocate a portion of TXOP time to STA 4 instead of STA 2. In another variant, MU RTS TXS trigger frame 244 may allocate a portion of TXOP time to each of peer STA 2 and STA 4 to offer to both stations an opportunity to send their P2P data to the other peer. In all these cases, after the notification 800 of step 730, TWT scheduling AP 110 allocates, using the Triggered TXOP Sharing, TXS, mechanism, one (or both) of the peer stations with a portion of time within an rTWT Service Period of the rTWT schedule.

Thereafter, as partner peer STA 4 is now present to exchange data with initiator peer STA 2, the latter can directly send its P2P data 846 to partner peer STA 4 within the rTWT SP 840, which peer, in response, performs acknowledgments (and optionally sends data) 847.

FIGS. 11 and 12 illustrate second embodiments where the two peer stations do not establish a Direct Link communication session.

FIG. 11 illustrates, using a flowchart, exemplary steps at the AP according to these embodiments, while FIG. 12 illustrates, using frame exchanges in a timeline, another scenario still with the AP notifying the partner peer about an rTWT schedule for P2P low latency traffic streams. The same references as in the previous Figures correspond to the same phases/steps/frames/entities.

In these embodiments, as no DiL communication session is established between the peers, the AP has to act as a relay to forward the P2P data from e.g. initiator peer STA 2 toward partner peer STA 4. Reasons of failing to have a TDLS or direct link communication established in between the two peers may be multiple, e.g. a coverage issue or TDLS capability or no common link for Multi-link devices.

As in FIG. 2 or 8, initiator peer STA 2 sets up an rTWT schedule with scheduling AP 110 (phase 220) as described above (definition of SCS P2P streams—221-222, negotiation of the rTWT schedule and establishment of membership therein—223-224).

Therefore, at step 710, similar to step 610, an rTWT agreement is established between initiator STA 2 and the AP, including for STA 2 to declare a SCS P2P stream (frames 221, 222) and to request membership in the rTWT schedule identified by bTWT ID (frames 223, 224).

During the rTWT setup phase 220, initiator peer STA 2 may (optionally) signal the identity (e.g. AID) of its partner peer, STA 4. Details on how the signalling is made are provided above with respect to the first embodiments of FIGS. 7 and 8.

At optional step 1115, TWT scheduling AP 110 facilitates communications for STA 2 member of the rTWT schedule. To that end, TWT scheduling AP advertises the rTWT schedule (bTWT ID in a broadcast TWT element) in Beacon frame 230 that indicates the next rTWT service period of the rTWT schedule the AP intends to allocate resources to STA 2. As only STA 2 has negotiated the rTWT schedule, only this station (and not STA 4) will be awake for rTWT SP 1240, as shown by the state bands 201, 202.

During rTWT SP 1240, TWT scheduling AP 110 may still send a PS-Poll Trigger frame 241 to be confirmed that initiator STA 2 is awake (PS-Poll frame 242 as a response). TWT scheduling AP 110 can block-acknowledge (243) the PS-Poll frames 242 to multiple TWT scheduled stations.

Next, TWT scheduling AP 110 sends a trigger frame 1244 to schedule uplink (UL) MU transmission by allocating time/frequency resources for one or more stations member of the rTWT schedule, including initiator peer STA 2. For example, a Basic Trigger frame is sent to provide a dedicated RU (resource unit) to STA 2 or a MU RTS TXS trigger frame is used to allocate time to STA 2.

In response to such a trigger frame 1244, triggered STA 2 transmits UL Buffer Data Units (Data1 1245) to the TWT scheduling AP within the allocated resources signalled in the trigger frame. Then, the TWT scheduling AP acknowledges (1245a) the reception of the UL data coming from STA 2.

By analysing the destination address into the MAC header of received Data1, the TWT scheduling AP realizes that the data are intended to another STA (peer STA 4). As a result, the AP transmits (relays) the data during a further downlink (DL) transmission 1250 toward destination peer STA 4.

At this stage or only based on step 710 (when step 1115 is omitted), the TWT scheduling AP determines, at step 720, that P2P data traffic exists between STA 2 and STA 4, and retrieves an identifier (AID or MAC address) of STA 4 which is not yet member of the rTWT schedule.

Again, detection of P2P data traffic can merely be made by detecting the presence of a Peer STA ID subfield 950, 964 or 1084 in SCS Request frame 821 or TWT Request frame 823 when implemented or detecting the relay 1115 of P2P data 1245/1250 from STA 2 to STA 4 or receiving a STA Information Announcement frame indicating partner peer STA information. It is recalled that the TWT scheduling AP is used to administrate the association between STA MAC Address and STA Association ID (AID), along with TWT membership for stations of its BSS.

Correspondingly, as mentioned above, the retrieval of STA 4's identifier may include one of the following:
retrieving one transmitter (e.g. source address (SA) identifying the initiator of the transmitted frame) or destination (e.g. destination address (DA) identifying the final recipient) MAC address of a MAC frame of P2P-related frame exchanged between the two peer non-AP stations. In this example, based on the destination MAC address of the P2P data 1245,
retrieving an AID of partner peer STA 4 from rTWT Setup frame 823 sent by peer STA 2 to establish its membership in the rTWT schedule,
retrieving an AID of partner peer STA 4 from SCS Request frame 821 sent by peer STA 2 to categorize a P2P traffic stream to be addressed to STA 4, and
retrieving an AID of partner peer STA 4 from a STA Information Announcement frame. This operates when the MAC address conveyed in the AID Entry field is different from the MAC Address of the STA transmitting the STA Information Announcement frame.

Considering that the relay 1115 of P2P data is liable to appear regularly based on the TWT agreement and the definition of the traffic characteristics obtained during step 710 (phase 220), the TWT scheduling AP may decide to seek to group the two steps 1245, 1250 of the global P2P transmission into one and the same rTWT SP negotiated by STA 2 for the uplink part. This is to minimize the delay between the uplink transmission and its subsequent downlink transmission and thus minimize the global transmission latency.

That is why, at step 730 already described with reference to FIGS. 7 and 8, the TWT scheduling AP enrols partner peer STA 4 in the rTWT schedule by notifying it about the rTWT schedule adhered by STA 2. In particular, the AP may send unsolicited TWT Setup frame 800 which comprises the identifier bTWT ID of the rTWT schedule. This is to establish membership of partner peer STA 4 in the rTWT schedule. Thanks to this establishment, the AP will be able to provide resources to both STA 2 and STA 4 within the service periods of that rTWT schedule.

At the end of step 730, both peer stations, STA 2 and STA 4, have now established membership in the same rTWT schedule. They are now able to correctly wake up for the service periods of the schedule.

The TWT scheduling AP can now facilitate (step 740) P2P data exchange between STA 2 and STA 4 within the service periods of the rTWT schedule, despite they have not established a DiL communication session.

TWT scheduling AP 110 includes a broadcast TWT element in Beacon frame 230a that indicates the rTWT schedule (bTWT ID) during which the AP intends to allocate resources to both STA 2 and STA 4. Both peer stations wake up to receive frame 230a.

As shown in state band 202, partner peer STA 4 now wakes up at the beginning of the rTWT SP 1260 corresponding to bTWT ID.

In the scenario shown, TWT scheduling AP 110 still sends a PS-Poll Trigger frame 241a to be confirmed that peer STA 2 and STA 4 are awake (PS-Poll frames 242a as responses). TWT scheduling AP 110 can block-acknowledge (243a) the PS-Poll frames 242a to multiple TWT scheduled stations. This polling is however optional.

Next, TWT scheduling AP 110 sends a trigger frame 1264 to schedule uplink (UL) MU transmission by allocating time/frequency resources for one or more stations member of the rTWT schedule, including peer STA 2 and/or peer STA 4. For example, a Basic Trigger frame is sent to provide a dedicated RU (resource unit) to STA 2 and/or STA 4 (if STA 4 has also P2P data to send), or a MU RTS TXS trigger frame is used to allocate time to STA 2 and/or time to STA 4.

In response to such a trigger frame 1264, triggered station (here STA 2 for illustrative purposes) transmits UL Buffer Data Units (Data2 1265) to the TWT scheduling AP within the allocated resources signalled in the trigger frame. Then, the TWT scheduling AP acknowledges (1265a) the reception of the UL data coming from STA 2.

In this scenario where both stations are members of the rTWT schedule and therefore participate to rTWT SP 1260, this uplink transmission can be directly followed, within the same rTWT SP 1260, by a downlink transmission 1266 of the received data Data2 1265 from AP to peer STA 4.

Compared to FIGS. 7 and 8, these second embodiments do not require the peer stations establish a DiL communication session (e.g. TDLS session) and the embodiments conduct the TWT scheduling AP to, after the notification, receive P2P data, typically HE Trigger-Based PPDUs, from one of the peer stations and relay them to the other peer station, typically using HE MU PPDUs, within the same rTWT Service Period of the rTWT schedule.

FIGS. 13, 14 and 15 illustrate third embodiments where the TWT scheduling AP, upon detecting the P2P traffic involving a peer station (STA 2) already member of an rTWT schedule, invites the partner peer station (STA 4) to establish a Direct Link communication session with the peer station.

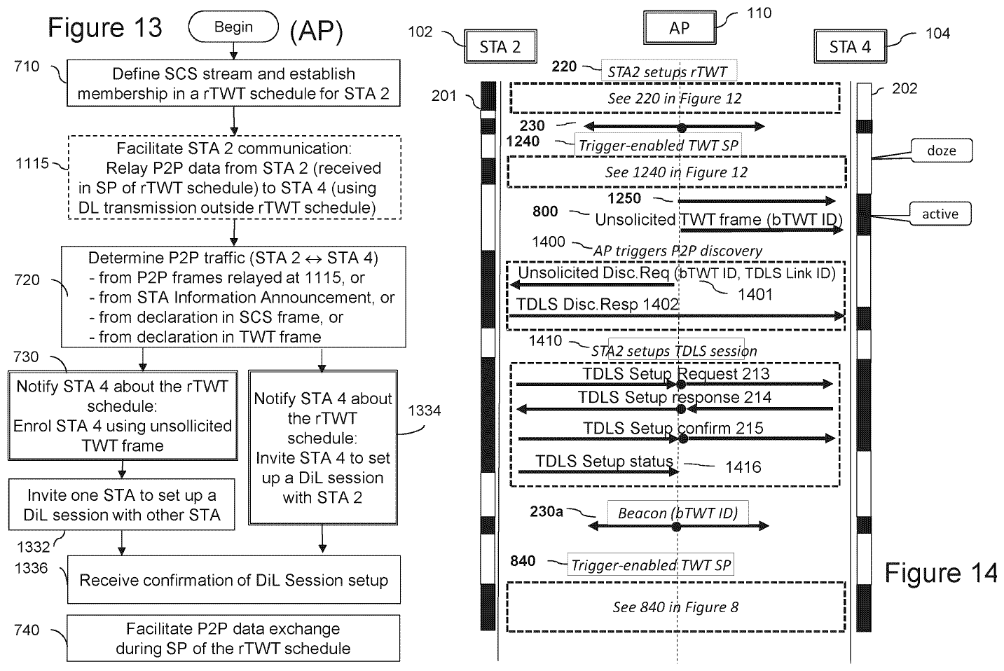

FIG. 13 illustrates, using a flowchart, exemplary steps at the AP according to these embodiments, while FIGS. 14 and 15 illustrate, using frame exchanges in a timeline, other scenarios still with the AP notifying the partner peer about the rTWT schedule for P2P low latency traffic streams. The same references as in the previous Figures correspond to the same phases/steps/frames/entities.

Similar to the second embodiments, no DiL communication session is initially established between the peers.

At step 710, initiator peer STA 2 sets up an rTWT schedule with scheduling AP 110 (phase 220) as described above (definition of SCS P2P streams, negotiation of the rTWT). An rTWT agreement is established between initiator STA 2 and the AP, including for STA 2 to declare a SCS P2P stream (frames 221/821, 222) and to request membership in the rTWT schedule identified by bTWT ID (frames 223/823, 224).

During the rTWT setup phase 220, initiator peer STA 2 may (optionally) signal the identity (e.g. AID) of its partner peer, STA 4, as shown by reference to frames 821 and 823. Details on how the signalling is made are provided above with respect to the first embodiments of FIGS. 7 and 8.

At optional step 1115, TWT scheduling AP 110 facilitates communications for STA 2 member of the rTWT schedule, during which TWT scheduling AP 110 relays Data 1 1245 received from STA 2 during a service period of the rTWT schedule, to STA 4 during a further downlink (DL) transmission 1250.

The TWT scheduling AP can determine, at step 720, that P2P data traffic exists between STA 2 and STA 4, and retrieves an identifier (AID or MAC address) of STA 4 which is not yet member of the rTWT schedule. Details on this step are provided above.

Responsive to such determination, the TWT scheduling AP notifies partner peer STA 4 about the rTWT schedule adhered by STA 2.

Two options are available for the AP, illustrated through the two branches of the flowchart. Both options provide the invitation for one of the peers, preferably partner peer STA 4, to establish a Direct Link communication session with the other peer, here STA 2 already member of the rTWT schedule.

In the first option, the TWT scheduling AP enrols partner peer STA 4 in the rTWT schedule by sending unsolicited TWT Setup frame 800 which comprises the identifier bTWT ID of the rTWT schedule. This is step 730 as already described above.

The invitation to establish a Direct Link communication session is additional to this notification. It is sent at step 1332. As the invitation 1332 is separate from the enrolment 730 of STA 4, the invitation may be sent to either STA 2 or STA 4.

This option corresponds to FIG. 14 with the invention being sent to peer STA 2.

In the second option, the invitation includes the notification about the rTWT schedule.

For example, a TDLS frame may be sent. As a consequence, partner peer STA 4 may be only informed of the rTWT schedule, without being enrolled (i.e. member of) in the rTWT schedule.

As another example, the unsolicited TWT Setup frame 800 may be sent as the invitation to partner peer STA 4. STA 4 may interpret this frame as also requesting a DiL session to be established with the peer (STA 2) mentioned in the frame, in case such DiL session does not yet exist. In this configuration, there is no need for the AP to send a TDLS (Discovery) frame and STA 4 is enrolled in the rTWT schedule.

The invitation/notification is sent at step 1334.

Embodiments of this option corresponds to FIG. 15.

In either option, the invitation suggesting the creation of a P2P or Direct Link communication between STA 2 and STA 4 may be an unsolicited TDLS Discovery (Request or Response) frame 1401 or a TDLS Setup suggest frame 1501.

As shown in the scenario of FIG. 14, the AP sends an unsolicited TDLS Discovery Request frame 1401 to either one of the two peer stations, thereby triggering a P2P Discovery procedure 1400. Generally speaking, in 802.11, a response frame is qualified as “unsolicited” when no corresponding request frame was emitted. In these embodiments, a request frame may also be qualified as “unsolicited” when the originator of the frame is not a legacy originator: Frame 1401 is therefore “unsolicited” because it is a frame built from scratch by the AP and not a frame received from one of the stations and relayed to the other as usually done for such type of frame.

The unsolicited TDLS Discovery Request frame 1401 is built by the TWT scheduling AP to mimic a conventional TDLS Discovery Request frame from the other peer station, i.e. with the address of the TDLS initiator at whom will be directed the TDLS Discovery Response frame. A format of such frame is shown in the right part of FIG. 3.

This unsolicited TDLS Discovery Request frame 1401 includes a TDLS link identifier (e.g. into Link identifier element, including information that identifies a TDLS direct link. The information are: BSSID of the BSS of which the TDLS initiator STA is a member, TDLS initiator STA Address to which corresponds the other peer station and TDLS responder STA address) and may optionally include bTWT ID (e.g. as sole TWT information as illustrated by reference 303a, or within a Broadcast TWT Info subfield 530 as illustrated by reference 303b or within a Restricted TWT Parameter Set subfield 520a as illustrated by reference 303c) to inform the STA that the P2P transmission covered by the TDLS session would be part of the TWT agreement and identified by bTWT ID.

To inform the TDLS responder STA (STA 2 in the example illustrated by the Figure) that unsolicited TDLS Discovery Request frame 1401 was built by the AP on behalf of the TDLS initiator STA (STA 4 in the example), the AP may use a specific reserved value in the Dialog Token field of the frame as described in FIG. 3.

In an alternative embodiment to the Dialog Token, a recipient STA may also detect that the station identified by SA address (originator) of MAC header of the frame 1401 corresponds to its AP (in such case, same as TA address). It is to be noted that the TDLS initiator STA address (STA 4 in the example) and TDLS responder STA address (STA 2 in the example) are still specified in the Link Identifier element of the TDLS Discovery Request frame in order to specify the appropriate TDLS peers. These addresses make it possible to confirm that none of TDLS STAs corresponds to the SA address of the frame.

In another alternative embodiment, the AP may transmit unsolicited TDLS Discovery Request frame 1401 to partner STA 4 to trigger the P2P discovery process, in replacement of unsolicited rTWT frame 800 in order to notify STA 4 about the rTWT schedule. This would correspond to the scenario of FIG. 15 using an unsolicited TDLS Discovery Request frame instead of TDLS Setup suggest frame 1501.

Upon receipt of unsolicited TDLS Discovery Request frame 1401, the TDLS responder station (STA 2) transmits TDLS Discovery Response frame 1402 to the station identified as TDLS STA initiator in the Link Identifier element of frame 1401, i.e. to STA 4 here. The TDLS Discovery Response frame 1402 includes a dialog token field filled with the same value as in unsolicited TDLS Discovery Request frame 1401.

As a result, thanks to the dialog token value matching the specific reserved value, the TDLS STA initiator (STA 4) infers that the TDLS Discovery procedure has been triggered by the AP. Otherwise, the TDLS Discovery Response frame would be considered by the TDLS STA initiator (STA 4) as an unsolicited TDLS Discovery Response frame (i.e. without prior transmission of a TDLS Discovery Request frame from STA 4's point of view), which could drive the TDLS STA initiator (STA 4) to respond with an individually addressed TDLS Discovery Response frame.

In a variant to unsolicited TDLS Discovery Request frame 1401, the AP may send an unsolicited TDLS Discovery Response frame which would include the same information about the rTWT schedule as for unsolicited TDLS Discovery Request frame 1401.

In a Multi-link case, the pair (unsolicited TDLS Discovery Request frame 1401, TDLS Discovery Response frame 1402) may be sent over different links supported by the AP MLD and the non-AP MLD (MLD of STA 2 in the example). To help the peer MLD to setup the P2P/DiL session, the AP may also include, in unsolicited Discovery Request frame 1401, some capability information about the other peer station (STA 4), for instance the multi-link capability, NSTR status, supported band of operation, and so on.

In another alternative embodiment, upon receiving unsolicited TDLS Discovery Request frame 1401 from the AP (clearly identifiable thanks to the Dialog Token element), the peer station (STA 2) may start the conventional TDLS Discovery procedure by transmitting a TDLS Discovery Request frame to the other peer station, TDLS STA initiator—STA 4, identified in frame 1401 (through the Link Identifier element). Next, peer STA 4 would respond by a TDLS Discovery Response frame.

In a variant, upon receiving unsolicited TDLS Discovery Request frame 1401 from the AP, the peer station (STA 2) may directly trigger the TDLS Setup process 1410 described below. Indeed, a TDLS station may send a TDLS Setup Request frame to another peer station in the same BSS to discover whether this other peer station is a TDLS STA. A TDLS Setup Response frame transmitted in response to a TDLS Setup Request frame indicates that the peer station sending the TDLS Setup Response frame is a TDLS STA.s

Once the TDLS Discovery phase 1400 has ended, conventional TDLS Setup Request frame 213, Response frame 214 and Confirm frame 215 can be exchanged during a TDLS session setup phase 1410, to set up the TDLS session.

When the TDLS setup handshake has been completed, the peer station having received invitation frame 1401 informs the AP about the status of the suggested TDLS session setup. To do so, a response ‘TDLS Setup Status frame’ 1416 to the invitation is sent confirming (or not) the establishment of the Direct Link communication session between the two peer non-AP stations. The AP therefore receives such TDLS Setup Status frame 1416. This is step 1336 of FIG. 13.

TDLS Setup Status frame 1416 may be a copy of the TDLS Setup Confirm frame 215 directed to the AP and containing only the following fields: Category, TDLS Action, Status Code and Dialog Token. The status code is used to effectively inform the AP about the TDLS Setup status. The status code may be filled with the values already described in the D1.5 standard or some new values taken among the reserved ones for instance to indicate that the peer STA is out of range or for link mismatch i.e. there is no common link in between the peer STAs or peer STA does not support EHT features (rTWT for instance). In case of failure of the Discovery process, the TDLS Setup status may be sent at the end of phase 1400 to indicate to the AP that the targeted STA (STA 4 in the example) is for example out of range. Preferably, Link Identifier element is also present to provide information that identifies a TDLS direct link (AP's BSSID, MAC addresses of TDLS Initiator STA and TDLS responder STA).

In case of successful TDLS session setup, at the end of step 1336, both peer stations, STA 2 and STA 4, have now established membership in the same rTWT schedule and have established the TDLS session. They are now able to correctly wake up for the service periods of the schedule.

The TWT scheduling AP can now facilitate (step 740) P2P data exchange between STA 2 and STA 4 within the service periods of the rTWT schedule, for example as already described with respect to rTWT SP 840 of in FIG. 8.

Turning now to the scenario of FIG. 15, the AP sends the invitation to establish a Direct Link communication session as a notification of the rTWT schedule adhered by STA 2. Therefore, the invitation is sent to the other peer station, STA 4. This is step 1334 of FIG. 13.

As mentioned above, the AP may send an unsolicited TDLS Discovery Request/response frame 1401 (as described above) to that end. However, in the scenario of the Figure, another invitation frame is proposed, called ‘TDLS Setup Suggest’ frame 1501, sent during P2P Setup suggestion phase 1500. Another variant mentioned above but not described in details is the use of Unsolicited TWT frame 800 acting as both the invitation to establish the DiL session and to enrol STA 4 in the rTWT schedule.

TDLS Setup Suggest frame 1501 includes the identity (e.g. AID) of the other peer station, STA 2, already member of the rTWT schedule (bTWT ID), and also includes TWT information about the rTWT schedule (any of 303a, 303b, 303c formats for example).

Frame 1501 may also include additional information such as STA 2 capability information already known by the AP (multi-link capability, NSTR status, supported band of operation . . . ) to help the station, STA 4, to setup the TDLS session.

TDLS Setup Suggest frame 1501 has therefore a dual role: to suggest a TDLS session setup and to inform the receiving peer station, STA 4, of an existing rTWT schedule the other peer station, STA 2, will use for transmission of P2P data.

Next, upon receipt of TDLS Setup Suggest frame 1501, the peer station, STA 4, sets up a TDLS session with the other peer station, STA2. Conventional TDLS Setup Request frame 1513, Response frame 1514 and Confirm frame 1515 (similar to frames 213, 214, 215 but from STA 4 to STA 2, instead of the other direction) can be exchanged during TDLS session setup phase 1510, to set up the TDLS session.

When the TDLS setup handshake has been completed, the peer station, STA 4, having received frame 1501 informs the AP about the status of the suggested TDLS session setup, as described above. To do so, a response ‘TDLS Setup Status frame’ 1516 to the invitation is sent confirming (or not) the establishment of the Direct Link communication session between the two peer non-AP stations. The AP therefore receives such TDLS Setup Status frame 1516. This is step 1336 of FIG. 13.

In case of successful TDLS session setup, at the end of step 1336, both peer stations, STA 2 and STA 4, have now established membership in the same rTWT schedule and have established the TDLS session. They are now able to correctly wake up for the service periods of the schedule.

The TWT scheduling AP can now facilitate (step 740) P2P data exchange between STA 2 and STA 4 within the service periods of the rTWT schedule, for example as already described with respect to rTWT SP 840 of in FIG. 8.

TDLS Setup Suggest frame 1501 and TDLS Setup Status frame 1416/1516 may be new TDLS Action frames (value 12 in Category field 301) so encapsulated in a data frame; or may be new Action frames of another category either an existing one, e.g. EHT or protected EHT (respectively value 36 or 37 in Category field 301) or in a new category of Action frame dedicated to P2P controlled by the AP (value to be taken from among the reserved Category field values).

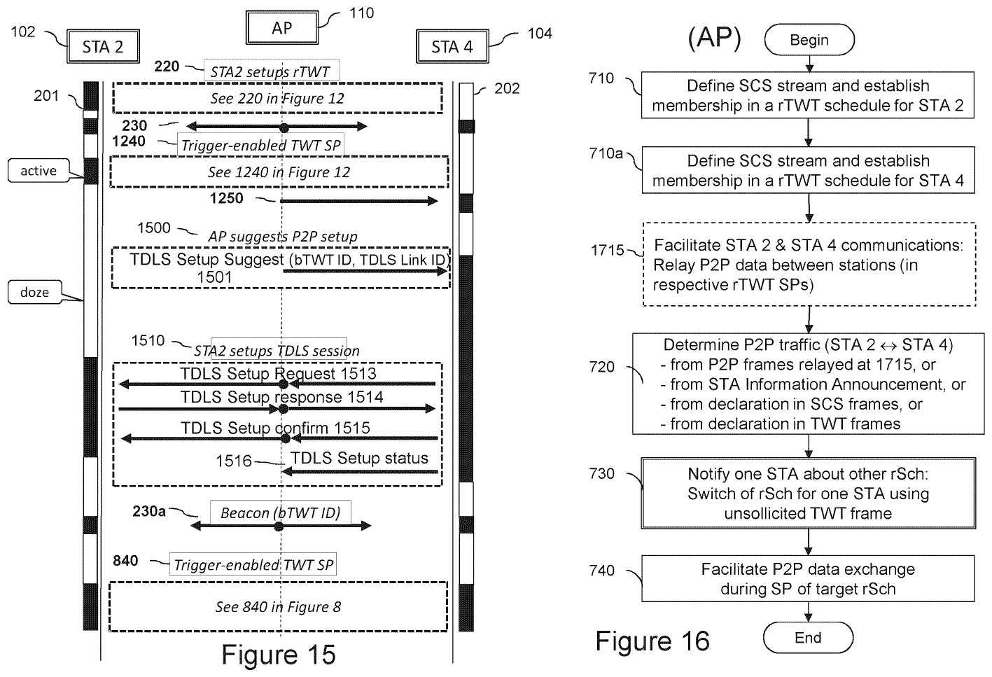

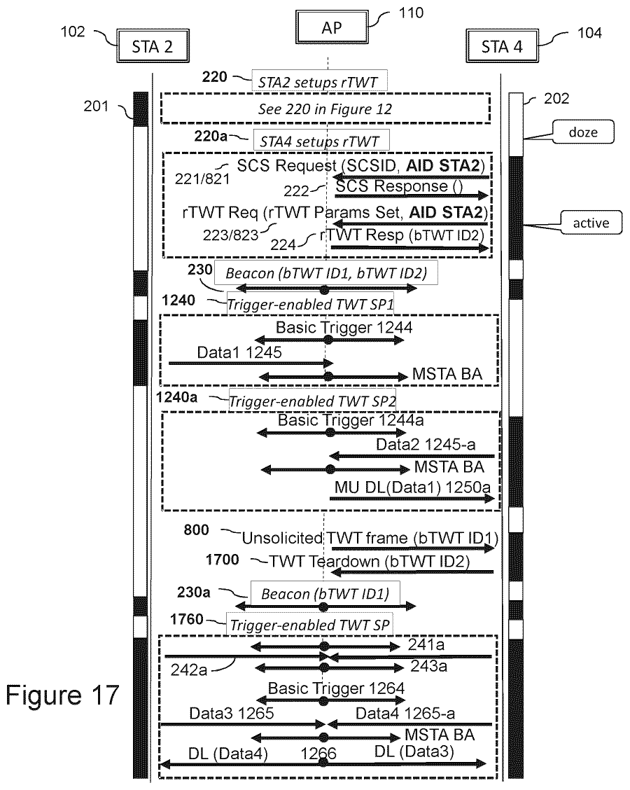

FIGS. 16 and 17 illustrate fourth embodiments where the two peer stations have previously established respective memberships in separate rTWT schedules managed by the AP.

FIG. 16 illustrates, using a flowchart, exemplary steps at the AP according to these embodiments, while FIG. 17 illustrates, using frame exchanges in a timeline, another scenario still with the AP notifying one of the peer stations to switch its membership from its rTWT schedule to the rTWT schedule adhered by the other peer AP station. The same references as in the previous Figures correspond to the same phases/steps/frames/entities.

Similar to previous embodiments, no DiL communication session is initially established between the peers. However, in a variant, they may have established such DiL communication session (as in the first embodiments).

At step 710, peer STA 2 sets up an rTWT schedule (referred to as rSch1) with scheduling AP 110 (phase 220) as described above (definition of SCS P2P streams, negotiation of the rTWT). An rTWT agreement is established between peer STA 2 and the AP, including for STA 2 to declare a SCS P2P stream (frames 221/821, 222) and to request membership in the rTWT schedule rSch1 identified by bTWT ID1 (frames 223/823, 224).

During rTWT setup phase 220, peer STA 2 may (optionally) signal the identity (e.g. AID) of its partner peer, STA 4, as shown by reference to frames 821 and 823. Details on how the signalling is made are provided above with respect to the first embodiments of FIGS. 7 and 8.

At step 710a, peer STA 4 also sets up an rTWT schedule (referred to as rSch2) with scheduling AP 110 (phase 220a) as described above (definition of SCS P2P streams, negotiation of the rTWT). An rTWT agreement is established between peer STA 4 and the AP, including for STA 4 to declare a SCS P2P stream (frames 221/821, 222) and to request membership in the rTWT schedule rSch2 identified by bTWT ID2 (frames 223/823, 224).

During rTWT setup phase 220a, peer STA 4 may (optionally) signal the identity (e.g. AID) of its partner peer, STA 2, as shown by reference to frames 821 and 823. Details on how the signalling is made are provided above with respect to the first embodiments of FIGS. 7 and 8.

After steps 710 and 710a, both peer stations have their own (but separate) rTWT schedules with the same AP. It means that at each service period of the rTWT schedule adhered by one of the peer stations, the other peer station remains in the doze state.

At optional step 1715, TWT scheduling AP 110 facilitates communications for STA 2 and STA 4, members of their respective rTWT schedules.

To that end, TWT scheduling AP advertises the rTWT schedules (bTWT ID1 for STA 2 and bTWT ID2 for STA 4 in broadcast TWT elements) in Beacon frame 230 that indicates the next rTWT service periods of each rTWT schedules the AP intends to allocate resources to STA 2 and STA 4 respectively. As only STA 2 has negotiated the rTWT schedule, only this station (and not STA 4) will be awake for rTWT SP 1240, as shown by the state bands 201, 202.

At rTWT SP 1240 of rSch1 (hence for STA 2), similar to rTWT 1240 of FIG. 12, TWT scheduling AP 110 may trigger the transmission of UL Buffer Data Units (Data1 1245) from STA 2 within allocated resources.

Similarly, at rTWT SP 1240a of rSch2 (hence for STA 4), again similar to rTWT 1240 of FIG. 12 but from STA 4 perspective, TWT scheduling AP 110 may trigger the transmission of UL Buffer Data Units (Data2 1245-a) from STA 4 within allocated resources.

Furthermore, by analysing the destination address into the MAC header of received Data1, the TWT scheduling AP realizes that the data are intended to peer STA 4. As a result, the AP transmits (relays) the data during rTWT SP 1240a using a downlink (DL) transmission 1250a toward destination peer STA 4.

Data2 may also be transmitted (not shown) to STA 2 in a further rTWT SP of rSch1, during a downlink (DL) transmission toward destination peer STA 2.

Based on phases 1240 and 1240a, the AP finds out that the uplink traffics from STA 2 and STA 4 are in reality cross P2P communications using the AP as a relay.

Considering that the relay 1715 of P2P data is liable to appear regularly based on the rTWT agreement and the definition of the traffic characteristics obtained during steps 710 and 710a (phases 220 and 220a), the TWT scheduling AP may decide to seek to group the two peer stations into the same unique rTWT schedule. This is to minimize the delay between the uplink transmission and its subsequent downlink transmission and thus minimize the global transmission latency.

The TWT scheduling AP can determine, at step 720, that P2P data traffic exists between STA 2 and STA 4, and retrieves an identifier (AID or MAC address) of one of the two peer stations. Details on this step are provided above, being noted that, due to the symmetry of the scenario, either of the two peer stations may be chosen for the rTWT schedule switch as described below.

Responsive to such determination, the TWT scheduling AP notifies the chosen peer station, let say STA 4, about the rTWT schedule rSch1 adhered by STA 2. In these embodiments, the notifying includes requesting the chosen peer station STA 4 to switch its membership from rSch2 to rSch1.

In particular, the AP may send unsolicited TWT Setup frame 800 which comprises the identifier bTWT ID1 of target rSch1. This is to switch the membership of STA 4 from rSch2 to rSch1. Thanks to this switch, both STA 2 and STA 4 will wake up for the same rTWT service periods.

To acknowledge the switch, peer STA 4 may send back a TWT Teardown frame 1700 related to rSch2 (bTWT ID2) to remove its membership therefrom.

At the end of step 730, both peer stations, STA 2 and STA 4, have now established membership in the same rTWT schedule, rSch1. They are now able to correctly wake up for the service periods of the schedule.

The TWT scheduling AP can now facilitate (step 740) P2P data exchange between STA 2 and STA 4 within the service periods of rSch1.

For example, TWT scheduling AP 110 includes a broadcast TWT element in the Beacon frame 230a that indicates the rTWT schedule rSch1 (bTWT ID1) during which the AP intends to allocate resources to both STA 2 and STA 4. Both peer stations wake up to receive frame 230a.

As shown in state band 202, partner peer STA 4 now wakes up at the beginning of the rTWT SP 1760 corresponding to bTWT ID1.

Optionally (not shown for clarity purposes), TWT scheduling AP 110 may send a PS-Poll Trigger frame to be confirmed that peer STA 2 and STA 4 are awake (PS-Poll frames sent as responses). TWT scheduling AP 110 can block-acknowledge the PS-Poll frames to multiple TWT scheduled stations.

Next, TWT scheduling AP 110 sends a trigger frame 1264 to schedule uplink (UL) MU transmission by allocating time/frequency resources for one or more stations member of the rTWT schedule, including peer STA 2 and peer STA 4. For example, a Basic Trigger frame is sent to provide dedicated RUs (resource units) respectively to STA 2 and STA 4, or a MU RTS TXS trigger frame is used to allocate time to STA 2 and time to STA 4.

In response to such a trigger frame 1264, both triggered stations STA 2 and STA 4 transmit their UL Buffer Data Units (Data3 1265 for STA 2 and Data4 1265-a for STA 4) to the TWT scheduling AP within the allocated resources signalled in the trigger frame. Then, the TWT scheduling AP acknowledges (1265a) the reception of the UL data coming from the peer stations.

In this scenario where both stations are members of the rTWT schedule and therefore participate to rTWT SP 1760, this uplink transmissions can be directly followed, within the same rTWT SP 1760, by a downlink transmission 1266 of the received data Data3 and Data4 from AP to respectively peer STA 4 and peer STA 2.

As a result, during the same TWT service period 1760, STA 2 and STA 4 transmit uplink data to the AP which relays these data to their respective final destination STA 4 and STA 2.

In embodiments, the scenario of FIG. 17 is improved by an invitation, from the AP to one of the peer stations, to establish a Direct Link communication session with the other peer station, as described above in the third embodiments. In that case, rTWT SP 1260a may allow the peer stations to directly (i.e. without relay by the TWT scheduling AP) transmit their P2P data to the other peer station during a service period of the rTWT schedule, using the Direct Link communication session.

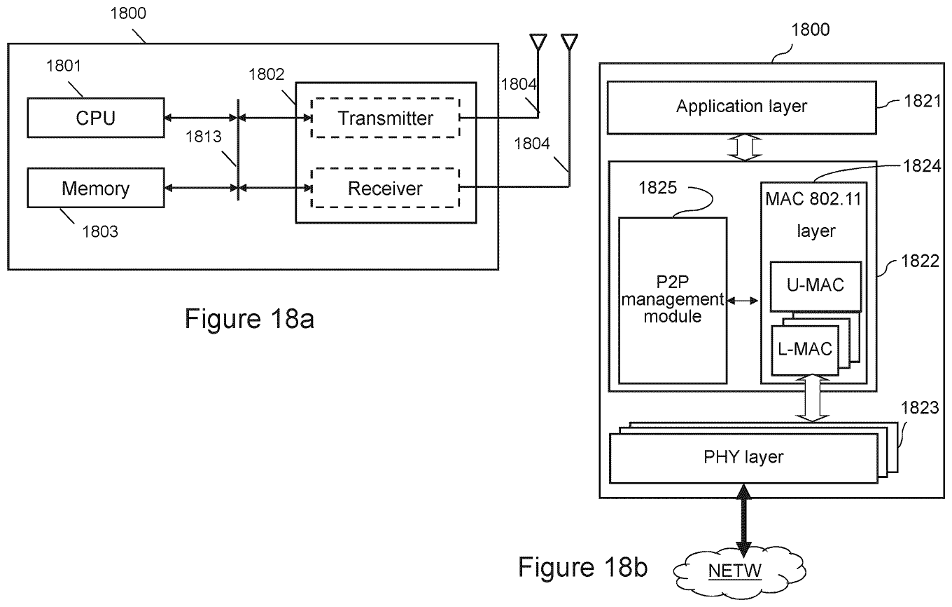

FIG. 18a schematically illustrates a communication device 1800, either a non-AP MLD, embedding a plurality of non-AP stations 101-107, or an AP MLD, embedding a plurality of APs 110, of a radio network NETW, configured to implement at least one embodiment of the present invention. The communication device 1800 may preferably be a device such as a micro-computer, a workstation or a light portable device. The communication device 1800 comprises a communication bus 1813 to which there are preferably connected:
a central processing unit 1801, such as a processor, denoted CPU;
a memory 1803 for storing an executable code of methods or steps of the methods according to embodiments of the invention as well as the registers adapted to record variables and parameters necessary for implementing the methods; and
at least one communication interface 1802 connected to a wireless communication network, for example a communication network according to one of the IEEE 802.11 family of standards, via transmitting and receiving antennas 1804.

Preferably the communication bus provides communication and interoperability between the various elements included in the communication device 1800 or connected to it. The representation of the bus is not limiting and in particular the central processing unit is operable to communicate instructions to any element of the communication device 1800 directly or by means of another element of the communication device 1800.

The executable code may be stored in a memory that may either be read only, a hard disk or on a removable digital medium such as for example a disk. According to an optional variant, the executable code of the programs can be received by means of the communication network, via the interface 1802, in order to be stored in the memory of the communication device 1800 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 18b is a block diagram schematically illustrating the architecture of the communication device 1800, adapted to carry out, at least partially, the invention. As illustrated, device 1800 comprises a physical (PHY) layer block 1823, a MAC layer block 1822, and an application layer block 1821.

The PHY layer block 1823 (here a multiple of 802.11 standardized PHY layer modules) has the task of formatting, modulating on or demodulating from any 20 MHz channel or the composite channel, and thus sending or receiving frames over the radio medium NETW, such as 802.11 frames, for instance medium access trigger frames to reserve a transmission slot, MAC data and management frames based on a 20 MHz width to interact with legacy 802.11 stations, as well as of MAC data frames of OFDMA type having smaller width than 20 MHz legacy (typically 2 or 5 MHz) to/from that radio medium.

The MAC layer block or controller 1822 preferably comprises a MLE MAC 802.11 layer 1824 implementing conventional 802.11 MAC operations, and additional block 1825 for carrying out, at least partially, embodiments of the invention. The MAC layer block 1822 may optionally be implemented in software, which software is loaded into RAM 1803 and executed by CPU 1801. The MLE MAC 802.11 layer 1824 may implement an Upper-MAC stack along with a series of Lower-MAC modules.

Preferably, the additional block 1825, referred to as P2P management module for performing low-latency service for P2P streams over multi-link communications, implements part of embodiments of the invention (at a peer non-AP MLD). This block performs the operations of FIGS. 6-17 depending on the role of the communication device 1800, TWT scheduling AP or peer station.

MAC 802.11-layer 1824 and P2P management 1825 interact one with the other in order to establish and process accurately communications over OFDMA RU in between multiple non-AP MLD stations according to embodiments of the invention.

On top of the FIG. 18b, application layer block 1821 runs an application that generates and receives data packets, for example data packets such as a video stream. Application layer block 1821 represents all the stack layers above MAC layer according to ISO standardization.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular, the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A peer-to-peer, P2P, communication method in a wireless network, comprising at an access point, AP, of a BSS:
establishing membership of a first peer non-AP station of the BSS in a restricted Target Wake Time, rTWT, schedule,
determining P2P data traffic between the first peer non-AP station and a second peer non-AP station of the BSS, and
responsive to the determining, notifying the second peer non-AP station about the rTWT schedule.

2. The method of claim 1, wherein the determining includes at least one from:
relaying P2P data exchanged between the two peer non-AP stations,
receiving P2P session setup frames exchanged between the two peer non-AP stations, to be relayed to the second peer non-AP station, and
receiving an indication of P2P data traffic within a frame to establish the membership in the rTWT schedule or a frame to setup a Stream Classification Service, SCS, P2P traffic stream.

3. The method of claim 1, further comprising, at the AP, obtaining an identifier of the second peer non-AP station to address the notification, wherein obtaining the identifier includes one of the following:
retrieving a transmitter or destination MAC address of a MAC frame of P2P-related frame exchanged between the two peer non-AP stations,
retrieving a MAC address or an Association Identifier, AID, of the second peer non-AP station from a STA Information Announcement frame sent by the first peer non-AP station to announce a partner peer non-AP station,
retrieving an AID of the second peer non-AP station from an rTWT Setup frame sent by the first peer non-AP station to establish its membership in the rTWT schedule, and
retrieving an AID of the second peer non-AP station from a Stream Classification Service, SCS, Request frame sent by the first peer non-AP station to categorize a P2P traffic stream to be addressed to the second peer non-AP station.

4. (canceled)

5. The method of claim 1, wherein notifying the second peer non-AP station about the rTWT schedule includes establishing membership of the second peer non-AP station in the rTWT schedule.

6. (canceled)

7. The method of claim 1, further comprising, at the AP, responsive to the determining, sending, to one of the peer non-AP stations, an invitation to establish a Direct Link communication session with the other peer non-AP station.

8-9. (canceled)

10. The method of claim 1, further comprising, at the AP, prior to the determining, establishing membership of the second peer non-AP station in a separate rTWT schedule, wherein the notifying includes requesting the second peer non-AP station to switch its membership from the separate rTWT schedule to the rTWT schedule of the first peer non-AP station.

11. The method of claim 1, further comprising, at the AP, after the notification, receiving P2P data from one of the peer non-AP stations and relaying them to the other peer non-AP station within the same rTWT Service Period of the rTWT schedule.

12. The method of claim 1, wherein the P2P data are received in HE Trigger-Based PPDUs and are relayed using HE MU PPDUs.

13. The method of claim 1, further comprising, at the AP, after the notification, allocating, using the Triggered TXOP Sharing, TXS, mechanism, one of the peer non-AP stations with a portion of time within an rTWT Service Period of the rTWT schedule.

14. A peer-to-peer, P2P, communication method in a wireless network, comprising at a second peer non-access point, AP, station of a BSS:
receiving, from an AP of the BSS, a notification about a restricted Target Wake Time, rTWT, schedule in which a first peer non-AP station of the BSS has established membership, and
exchanging, during one or more rTWT service periods of the rTWT schedule, P2P data with the first peer non-AP station.

15. The method of claim 14, wherein the notification about the rTWT schedule includes establishing membership of the second peer non-AP station in the rTWT schedule.

16. (canceled)

17. The method of claim 1, wherein the notification further signals an identifier of the first peer non-AP station.

18. The method of claim 14, further comprising, at the peer non-AP station, receiving, from the AP, an invitation to establish Direct Link communication session with the first peer non-AP station.

19-21. (canceled)

22. The method of claim 14, further comprising, at the peer non-AP station, prior to receiving the notification, establishing, with the AP, membership in a separate rTWT schedule, wherein the notification includes a request to switch its membership from the separate rTWT schedule to the rTWT schedule in which the first peer non-AP station has established membership.

23. The method of claim 14, further comprising, at the peer non-AP station, after receiving the notification, receiving, from the AP and within an rTWT Service Period of the rTWT schedule, P2P data emitted by the first peer non-AP station.

24. The method of claim 14, further comprising, at the peer non-AP station, after receiving the notification, being allocated, based on the Triggered TXOP Sharing, TXS, mechanism, a portion of time within an rTWT Service Period of the rTWT schedule and directly exchanging P2P data with the first peer non-AP station within the allocated time portion.

25. The method of claim 1, wherein the two peer non-AP stations have established a P2P session prior to the notification.

26. The method of claim 1, wherein the notification about the rTWT schedule includes information about a Broadcast TWT identifier, bTWT ID, identifying the rTWT schedule, wherein the notification about the rTWT schedule provides one from:
only the bTWT ID as TWT information,
a Broadcast TWT Info subfield including the bTWT ID, and
a Restricted TWT Parameter Set subfield including the bTWT ID.

27-30. (canceled)

31. A wireless communication device comprising at least one microprocessor configured for carrying out the steps of the method of claim 1.

32. A non-transitory computer-readable medium storing a program which, when executed by a microprocessor or computer system in a wireless device, causes the wireless device to perform the method of claim 1.
